(19) United States
(12) Patent Application Publication
(10) Pub. No.: US 2004/0003070 A1
(43) Pub. Date: Jan. 1, 2004

(54) Centrally controlled end-to-end service quality monitoring system and method in a distributed environment

(75) Inventors: Steven A. Fernald, Auburn, CA (US); Evan L. Powell, Sausalito, CA (US); Kevin McGowan, Monument, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Clarus Systems, Inc., San Francisco, CA

(21) Appl. No.: 10/184,224

(22) Filed: Jun. 26, 2002

(51) Int. Cl. G06F 15/173

(52) U.S. Cl. 709/223

(57) ABSTRACT

A system (and methods) for monitoring telecommunications services end-to-end through a distributed network environment. The system includes a distributed telecommunication network, which is capable of providing communications to a plurality of users during an active state. The system also has a plurality of point of presence servers distributed throughout the cities served by the distributed telecommunication network. Each of the point of presence servers is adapted to provide a test pattern from a plurality of test patterns where each of the test patterns correspond respectively to one of a plurality of services. The test pattern is transferred from one of the point of presence servers to another point of presence server to identify a quality level of the distributed telecommunication network between the one point of presence server and the other point of presence server. Other features are also included.

### BACKGROUND OF THE INVENTION

The present invention is generally related to telecommunication networks. More particularly, the invention provides a method and system for monitoring and analyzing quality of service from end-to-end (e.g., caller to receiver) using a simulation during an active state of a telecommunication network. Merely by way of example, the invention is applied to a carrier grade telecommunication network. But it will be recognized that the invention can be applied to other networks, such as local area networks, mobile wireless networks, fixed wireless networks, mobile satellite networks, fixed satellite networks, fiber networks, cable networks, enterprise private networks, enterprise Virtual Private Networks (VPN), enterprise extranet networks, a plurality of variations and customizations of each network, any combination of these and the like.

Over the years, telecommunication techniques have rapidly changed. A long time ago, Greeks and Romans relied on communications between villages by way of fires and smoke signals. Although effective in its days, such smoke signals were often limiting in the amount of information carried. Additionally, rain, wind, and other weather factors often hampered with such signals in an undesirable manner. Other forms of communication included the use of jungle drums, which transmitted information through sound between villages in Africa. Although such drums could convey more information than smoke signals, the drums were also limiting in the amount of information transmitted. More recently, Samuel F. B. Morse invented telegraph communications in the early 1800's. Telegraph carried electrical signals through wires disposed between towns. Such electrical signals included dots and dashes, which were used to represent certain letters of the alphabet. Such dots and dashes were commonly referred to as “Morse code.” Even though telegraph was fairly successful, the amount of information contained in the dots and dashes was still limiting.

Telephone soon replaced, in part, telegraph. More particularly in the late 1800s, Alexander Graham Bell invented the telephone system which carried voice signals from a source to a destination through wires. Hard wires were used to connect cities to cities, houses to houses, and the like. Telephone soon became a part of everyday life where millions of people made calls to each other to exchange information. By the 1990s, the use of computers that were connected to the telephone wires had also become widespread. Such computers communicated to each other using data packet communication over the telephone networks. One of the most famous of such networks, which connected computers around the world to each other, was called the “Internet.”

Data packet communication on the Internet is dominated by traffic transported using a transport communication protocol/Internet protocol (TCP/IP) suite of protocols. The Internet protocol (IP) header of these packets contains information related to recipient and sender addresses and ports, packet size, and protocol encapsulated in the IP packet, such as transport communication protocol (TCP), user datagram protocol (UDP), or Internet control message protocol (ICMP). A data packet (“packet”) is a finite set of data and associated control bits of a standard maximum size, having a predefined protocol and organization. Such data are effectively transported through the Internet between users.

Telecommunication techniques used in data communication are now being implemented for voice communication. In the U.S., the telecommunication industry has undergone tremendous changes by way of introductions of the distributed Internet Protocol (IP) based switches, which were used with data communication. Industry has attempted to use such switches for communicating voice signals through the Internet. A variety of limitations, however, exist. Although effective in transporting data, which are not quality sensitive, transporting voice, video, or other quality sensitive services has been difficult. As merely an example, many quality related problems exist with voice communication over data networks. To improve such quality related problems, there have been attempts to monitor information from each of the network elements in these data networks. But such attempts only monitored the internal state of such elements.

No information about the end-to-end quality of the service delivered to users of those services generally exists in most conventional networks. In addition, it is often very difficult to use monitor information from each of the network elements to discern whether or not any of those messages are related to actual degradations of the end-to-end services delivered to customers of those services. If one is able to determine from monitor information that a network element has indeed failed, it is still difficult, in a packet network, to know if the failure of any particular network element has caused any actual degradations of the end-to-end services delivered to customers of those services. Other performance information is available that describes the performance quality viewed from the internal state of the active network. Such measures include packet loss, packet latency, and packet latency jitter. As this performance information does not in any way reflect any degradations of service quality that may have been caused by network elements on the edge of the network, in particular those network elements involved in transforming the services, carried by digital packets inside the network, into the native mode of transmission particular to each service. In many cases the native mode of transmission is analog, so it is not possible to monitor the end-to-end service quality by methods involving the observation of packet performance measures. These and other difficulties exist with conventional data networks, which are being used for quality sensitive services.

From the above, it is seen that techniques for monitoring telecommunication networks are desired.

### BRIEF SUMMARY OF THE INVENTION

According to the present invention, improved techniques for measuring the end-to-end service quality of telecommunication networks are provided. More particularly, the invention provides a method and system for monitoring and analyzing quality of service from end-to-end (e.g., caller to receiver) using a simulation process during an active state of a telecommunication network. Merely by way of example, the invention is applied to a carrier grade telecommunication network such as those used by conventional telephone service companies. But it will be recognized that the invention can be applied to other networks, such as local area networks, mobile wireless networks, fixed wireless networks, mobile satellite networks, fixed satellite networks, fiber networks, cable networks, enterprise private networks, enterprise Virtual Private Networks (VPN), enterprise extranet networks, a plurality of variations and customizations of each network, and any combination of these and the like.

In a specific embodiment, the invention provides a system for monitoring telecommunications services end-to-end through a distributed network environment. The system can include or be implemented in a distributed telecommunication network, which is capable of providing communications to a plurality of users during an active state. The system also has a plurality of point of presence servers distributed throughout the cities (e.g., distributed geographically) served by the distributed telecommunication network. Each of the point of presence servers is adapted to provide a test pattern (i.e., one or more patterns or a portion of a pattern) from a plurality of test patterns where each of the test patterns corresponds respectively to one of a plurality of services. Such services may be the same or different. The test pattern is transferred from one of the point of presence servers to another point of presence server to identify a quality level of the distributed telecommunication network between the one point of presence server and the other point of presence server. The system also has a master controller coupled to each of the point of presence servers via the system's Internet Protocol Wide Area Network (i.e., IP-WAN). The master controller is adapted to select one of the services to be simulated by one of the point of presence servers where the one point of presence server transferred the test pattern associated with the selected service to the other point of presence server. The master controller is adapted to receive information associated with the quality level of the distributed telecommunication network from one or more of the point of presence servers.

In an alternative specific embodiment, the invention provides an alternative system for monitoring telecommunications services end-to-end through a distributed network environment. The system has a plurality of point of presence servers distributed throughout (e.g., geographically or spatially) a distributed telecommunication network. Each of the point of presence servers is adapted to provide a test pattern from a plurality of test patterns whereupon each of the test patterns corresponds respectively to one of a plurality of services. The test pattern is transferred from a first point of presence server to a second point of presence server to identify a quality level of the distributed telecommunication network between the first point of presence server and the second point of presence server. A master controller is coupled to each of the point of presence servers through the network. The master controller is adapted to select one of the services to be simulated by the first point of presence server whereupon the first point of presence server transfers the test pattern associated with the selected service to the second point of presence server. The master controller is adapted to monitor information associated with the quality level of the distributed telecommunication network from one or more of the point of presence servers.

Numerous benefits are achieved using the present invention over conventional techniques. For example, the invention can be used to monitor quality of service on an end-to-end basis for a variety of services, a variety of users, through a variety of networks, which may be the same or different. Preferably, the invention can be applied to an active network, where a simulation is used with a plurality of test patterns or a single test pattern, which are transparent to active users of the network. In a specific embodiment, the present method and system can be implemented using conventional hardware and software technology. The present method and system allows for the economic benefits of reusing the overall system and IP-WAN and the individual point of presence servers to monitor quality of service for a plurality of services that are carried by a plurality of networks and a plurality of technologies. The present method and system allows the rapid isolation of service quality degradations by the transfer of a test pattern into an active network from a plurality of point of presence servers to a plurality of point of presence servers creating a matrix of service quality measures for comparison. The present method and system allows a unique view of service quality that was, heretofore, available only to human subscribers of those services. In addition, the system contains a knowledge base built from transfers of a test pattern to a plurality of services transmitted over a plurality of network technologies. This broadly informed knowledge base enables the very rapid diagnosis of underlying network problems that cause degradation of end-to-end service quality. Depending upon the embodiment, one or more of these benefits may be achieved. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of an overall system according to embodiment of the present invention.

FIG. 1a is a simplified diagram of test pattern being transferred during the active state of a distributed telecommunication network.

FIG. 1b is a simplified diagram of a received test pattern being compared with a stored test pattern.

FIG. 2 is a simplified diagram of a master controller according to embodiment of the present invention.

FIG. 3 is a simplified diagram of a point of presence (“POP”) server according to embodiment of the present invention.

FIGS. 4 to 15 are simplified diagrams various network service applications according to embodiments of the present invention.

FIG. 16 is a simplified diagram of an overall system according to an alternative embodiment of the present invention.

FIG. 17 is a simplified diagram of an overall system according to an alternative embodiment of the present invention.

FIG. 18 is a flow chart illustrating a method of measuring and analyzing end-to-end service quality in an active network.

FIGS. 19(A-C) is a flow chart illustrating an alternative method of measuring and analyzing end-to-end service quality in an active network.

FIGS. 20(A-D) is a flow chart illustrating another alternative method of measuring and analyzing end-to-end service quality in an active network.

### DETAILED DESCRIPTION OF THE INVENTION

According to the present invention, improved techniques for monitoring and measuring the end-to-end service quality of telecommunication networks are provided. More particularly, the invention provides a method and system for monitoring and analyzing quality of service from end-to-end using a simulation during an active state of a telecommunication network. Merely by way of example, the invention is applied to a carrier grade telecommunication network. But it will be recognized that the invention can be applied to other networks, such as local area networks, mobile wireless networks, fixed wireless networks, mobile satellite networks, fixed satellite networks, fiber networks, cable networks, enterprise private networks, enterprise Virtual Private Networks, enterprise extranet networks, a plurality of variations and customizations of each network, any combination of these and the like.

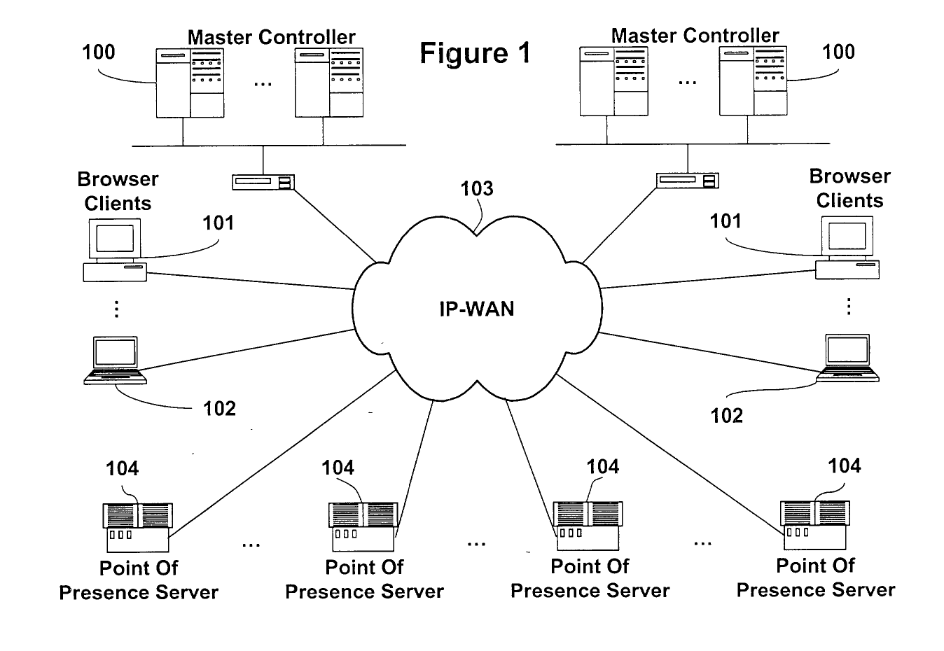

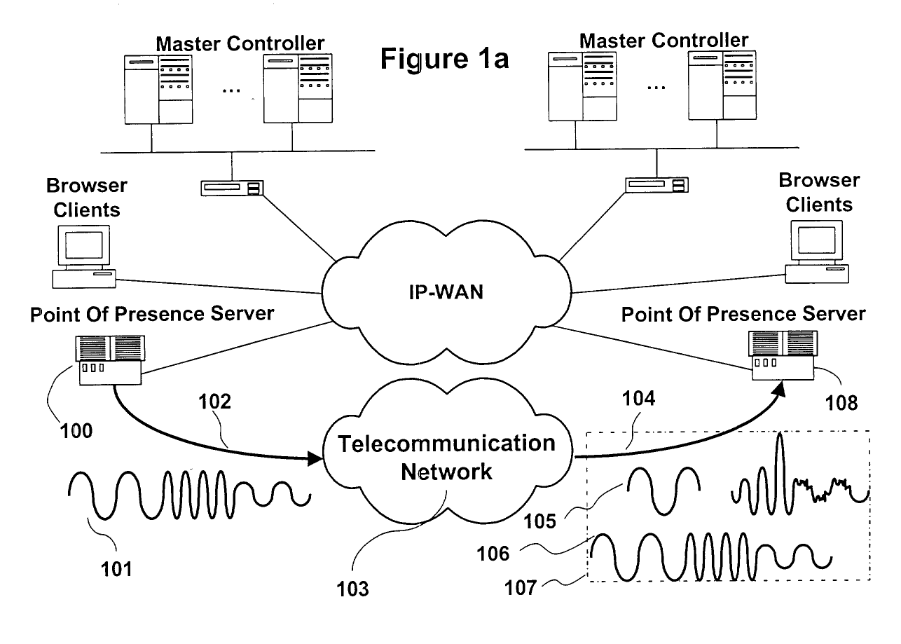

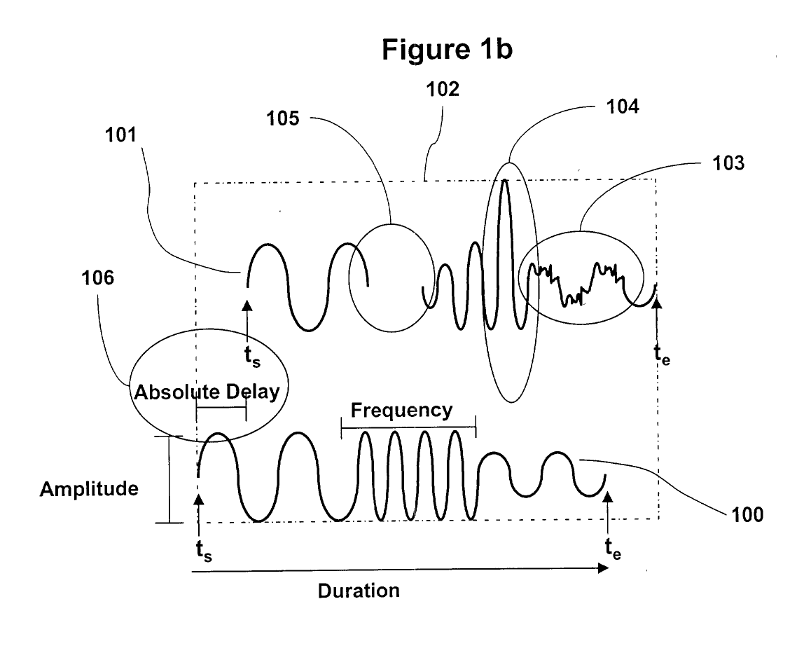

FIG. 1 is a simplified diagram of an overall system according to an embodiment of the present invention. This diagram is merely an example, which should not unduly limit the scope of the claims herein. One of ordinary skill in the art would recognize many other variations, modifications, and alternatives.

The system shown in FIG. 1 typically includes redundant Master Controller computer systems 100, a plurality of Point of Presence Server computer and test systems 104, a plurality of Internet Browser Clients belonging to customers, either a work station 101 in a semi-permanent location, a laptop 102 that is mobile from one location to another, or any other web accessible device. The system includes an IP-WAN data network 103 that uses the Internet to interconnect the various computers and web browsers.

As illustrated, via the IP-WAN data network, 103 software in the Master Controller computer systems 100, controls one or all the Point of Presence Server 104 systems in ways necessary to enable the full operation of this system for end-to-end service quality testing over a plurality of networks belonging to a plurality of customers over a plurality of network technologies. These functions include, but are not limited to: scheduling of test pattern transfers for monitoring at a predetermined time, which may be automatic or semi-manual, or manual, scheduling of test pattern transfers for user requested demand testing, management of the operation and data communication between itself and a plurality of Point of Presence Server systems, management of overall system operations and reliability for the software and hardware in the Master Controller systems and in the plurality of Point of Presence Server systems, and the collection of measurement results from the Point of Presence Server systems.

As also illustrated in the drawing, via the IP-WAN, software in the Master Controller computer systems 100 controls one or all user interactions with the system, the plurality of users gaining access to the system via Internet Browser Clients 101 and 102. These interactions support many user functions including: user access control including user name, password and security, the selection of monitoring measurement results for display, the set-up and initialization of network routes in preparation for the scheduling of test pattern transfers for monitoring and demand sampling, the analysis of measurement results, the display of monitoring measurement results, the selection of demand measurement results for display, the display of monitoring measurement results and the initiation of test pattern transfers for demand testing samples.

As also illustrated in the drawing, software in the Point of Presence Server 104 controls selected or all interactions with the test system that is part of the VCS POP. These interactions include: configuration and set up, status, selection of test pattern, the simulation of an end user interacting with the service under test (functions such as connecting to the service under test, inputting service operational data, inputting command information altering the behavior of the service, requesting additional functions from the service, and any other user interactions appropriate to the service under test), sending test patterns, and analyzing test patterns for quality. In addition, software in the Point of Presence Server systems control the interaction of each pair of Point of Presence Server systems, each with the other, while they are transferring test patterns in first one direction and then in the opposite direction to the first direction to form full duplex operation. The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below. FIG. 1a is a simplified diagram of test pattern being transferred during the active state of a distributed telecommunication network. This diagram is merely an example, which should not unduly limit the scope of the claims herein. One of ordinary skill in the art would recognize many other variations, modifications, and alternatives.

The system shown in FIG. 1a is the system previously described in FIG. 1. FIG. 1 has been modified as shown in FIG. 1a to include a simplified representation of the process for transmitting a test pattern end-to-end during the active state of a distributed telecommunication network. FIG. 1a also includes a simplified representation of the comparison performed by the second Point of Presence Server 108 in order to determine a quality level of the received test pattern. For simplicity, FIG. 1a represents just one of the directions that test patterns are transferred by the system.

As shown in FIG. 1a, a first Point of Presence Server 100 will select test patterns, from a plurality of test patterns that are optimized to simulate human voices. The selected test pattern 101, here represented in a schematic fashion as a simple waveform is transferred via an access network 102 from a first Point of Presence Server 100 to the distributed telecommunication network 103. The selected test pattern is then transported across the telecommunication network 103 and transferred via a second access network 104 to a second Point of Presence Server 108. The second Point of Presence Server receives the transferred test pattern 105 and prepares to determine the quality level of the received test pattern.

The second Point of Presence Server selects, from a plurality of stored test patterns, a test pattern 106 that will be compared with the received test pattern 105 to determine a quality level of the received test pattern. The particular stored test pattern selected 106 is one designed to match the original test pattern 101 as transferred from the first Point of Presence Server 100. In addition, the second Point of Presence Server will use a time reference frame 107 to determine the absolute time delay added to the original test pattern 101 in being transmitted end-to-end during the active state of the distributed telecommunication network.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

FIG. 1b is a simplified diagram of a received test pattern being compared with a stored test pattern. This diagram is merely an example, which should not unduly limit the scope of the claims herein. One of ordinary skill in the art would recognize many other variations, modifications, and alternatives. To determine a quality level of a received test pattern 101 it is compared with a stored test pattern 100. These comparisons are made in several domains selected to best determine the quality level of the received test pattern 101. In this example the selected domains are duration (as noted by start time tₛ and the end time tₑ, amplitude, frequency, and absolute delay. Test patterns may suffer degradations in any or all of the selected domains. Each degradation will contribute to a lower quality level end-to-end and are discovered by process that compares the stored test pattern 100 to the received test pattern 101.

As shown in FIG. 1b the received test pattern, here represented in a schematic way as simple waveforms, has suffered several degradations while being transferred through the active state of a telecommunication network. Compared to the stored test pattern 100 the received test pattern 101 has, in part, had its fidelity of reproduction distorted 103. Compared to the stored test pattern 100 the received test pattern has also been degraded by a distortion of amplitude 104. In addition, when compared to the stored test pattern 100 the received test pattern is missing information that has been lost during transfer 105. Finally, when compared in a time reference frame 102 the received test pattern 101 has incurred absolute delay 106 as shown by the difference between the tₛ of the stored test pattern 100 and tₛ of the received test pattern 101.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

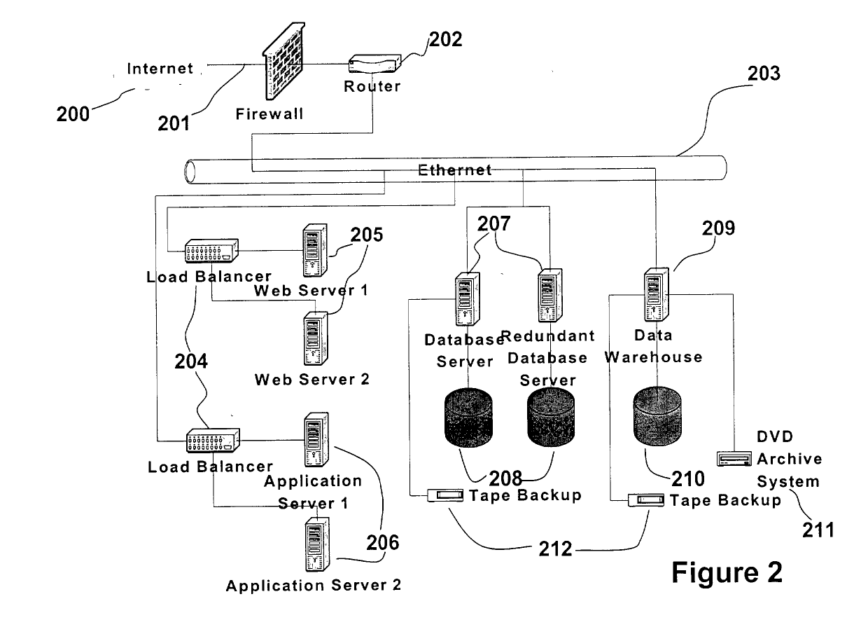

FIG. 2 is a simplified diagram of a Master Controller according to an embodiment of the present invention. This diagram is merely an example, which should not unduly limit the scope of the claims herein. One of ordinary skill in the art would recognize many other variations, modifications, and alternatives. The system shown in FIG. 2 typically includes the subsystems that comprise the Master Controller, interconnected via an Ethernet LAN 203. The IP-WAN 200 (Internet) is used to supply data connections to user's browser client systems by which users interact with the Master Controller to perform functions including, but not limited to: control and modify monitoring, control and modify demand testing, examine graphic displays and reports, receive notifications, and administrative user functions. The IP-WAN 200 is also used to supply data connections between the Master Controller and POP Servers for purposes including but not limited to: the scheduling of test pattern transfers for monitoring, the scheduling of test pattern transfers for user requested demand testing, the management of the operation and data communication between itself and a plurality of Point of Presence Server systems, the management of overall system operations and reliability for the software and hardware in the Master Controller systems and in the plurality of Point of Presence Server systems, and the collection of measurement results from the Point of Presence Server systems. Any and all data is sent to, or received from, the IP-WAN 200 via a Firewall 201. The firewall maintains security for data access to the Master Controller, insuring that only authorized transactions are enabled. A router 202 connects the Ethernet LAN to the IP-WAN.

Redundant Web Servers 205 provide computing resources for the software that provides the content and formatting of graphics, reports, and control screens. Redundant Application Servers 206 provide computing resources for the software that performs any and all detection, isolation, diagnosis, and other functions involving the analysis of test pattern results. These four computers are connected to the Ethernet LAN 203, and hence to the IP-WAN and the public Internet, by redundant Load Balancers 204.

Redundant Database Servers 207 provide computing resources for relational database management software that provides the Master Controller with the ability to store and retrieve any and all needed data elements needed for On Line Transaction Processing (OLTP), including test pattern measurement results, network description data, user description data, and other control information. Redundant RAID disk drives 208 provide physical media for the storage of relational database data elements.

The Data Warehouse 209 provides computing resources for software that provides the Master Controller the ability to support On Line Analytical Processing (OLAP) for the storage and analysis of historical test pattern measurement results. RAID disk drive 210 provides physical media for the storage of OLAP database data elements.

The DVD Archival System 211 provides the Master Controller with the capability of storing large amounts of historical test pattern measurement results off line with the ability to reload results into the OLAP system. Tape Backup systems 212 provide for periodic back up of some or all Master Controller software, control data, test pattern measurement results, and other operational data elements. The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

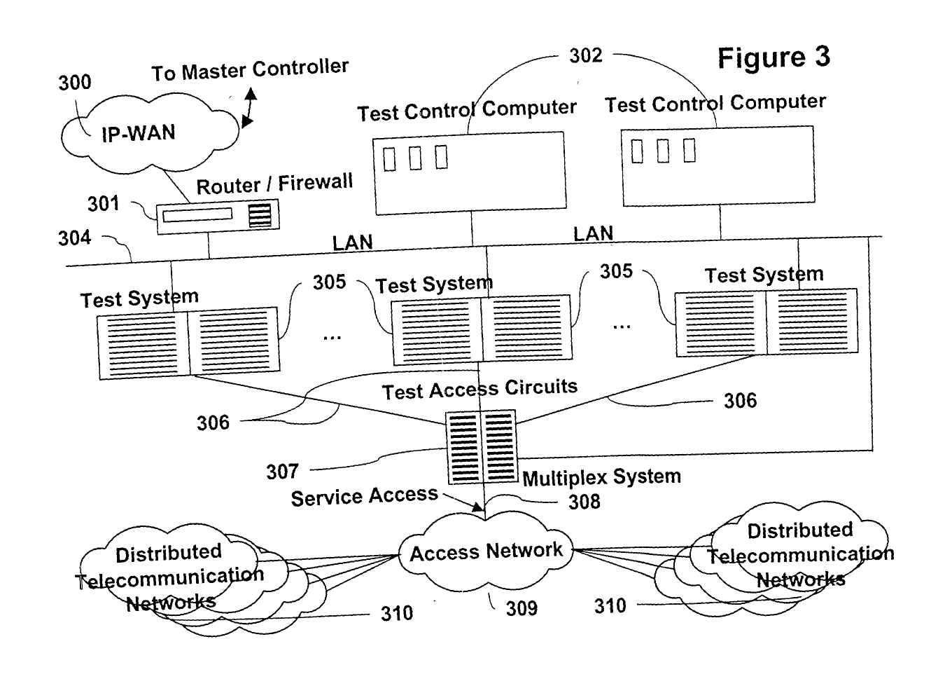

FIG. 3 is a simplified diagram of a point of presence (“POP”) server according to embodiment of the present invention. This diagram is merely an example, which should not unduly limit the scope of the claims herein. One of ordinary skill in the art would recognize many other variations, modifications, and alternatives. The system shown in FIG. 3 typically includes the subsystems that typically comprise a Point of Presence Server, interconnected for data communications, via an Ethernet LAN 304. The IP-WAN 300 is used to supply data connections between a Point of Presence (POP) Server and the Master Controller for purposes including, but not limited to: the scheduling of test pattern transfers for monitoring, the scheduling of test pattern transfers for user requested demand testing, the management of the operation and data communication between itself and a plurality of Point of Presence Server systems, the management of overall system operations and reliability for any and all the software and hardware in the Master Controller systems and in the plurality of Point of Presence Server systems, and the transport of measurement results from the Point of Presence Server system to the Master Controller.

All data sent to, or received from, the IP-WAN 300 is via a Router/Firewall 301. The firewall function of the Router/Firewall maintains security for data access to the Point of Presence Server, insuring that only authorized transactions are enabled. Router functions of the Firewall/Router connects the Ethernet LAN to the IP-WAN. Redundant Test Control Computers 302 provide computing resources for the software that performs some or all control, formatting, and management functions at the Point of Presence Server system including: receipt, formatting, and management of instructions from the Master Controller, control of the Test Systems 305, transmission and formatting of test pattern measurement result data to the Master Controller, and related operational and maintenance functions.

A plurality of Test Systems 305, of various type suited to the plurality of services under test and network technologies supporting those services, are controlled by the Test Control Computers 302 via the LAN 304. Upon receipt of instructions from the Master Controller the Test Control Computers systems will select which Test System is best suited to support the transmission of the requested test pattern that via the active state network of a particular technology. The Test Control Computers 302 then will format a set of test control commands and transmit them to the selected Test System 305 via the LAN 304. When the Test System 305 has completed the transmission of the selected test patterns to one of the Test Systems 305 at a geographically separate Point of Presence Server, it will report the measurement results to the Test Control Computer systems 302. The Test Control Computer systems 302 will then format and transmit those results to the Master Controller via the Ethernet LAN 304 and the IP-WAN 300.

Test Access Circuits 306 connect the Test Systems 305 to the Multiplex System 307 that is, in turn, connected via Service Access 307 to the Access Network 309 and via the Access network to the plurality of services supported by the Distributed Telecommunication Networks 310. Test Access circuits 306 are composed of a range of technologies appropriate to the plurality of services and network technologies being tested and provide connections that remain within the physical location of one of the Point of Presence Servers and provide intra-location connections for the transmission of test patterns. The Multiplex System also is linked to the Test Control Computer Systems via the Ethernet LAN 304. The Multiplex System 305 performs a “grooming” function by allowing, at the command of the Test Control Computer Systems 302, the connection of one of a plurality of Test Systems 305 to one of a plurality of Distributed Telecommunication Networks 310 as needed while avoiding having service access capacity idle. Service Access circuits 308 are composed of a range of technologies appropriate to the plurality of services and network technologies being tested and provide connections from the Point of Presence Servers to the public local access network 309 for the purpose of providing transport connections for the transmission of test patterns. Service Access circuits 308 are of many types and technologies and are designed to accurately emulate the actual access methods used by actual customers of the service under test to gain access to that service. In summary, the interconnection of Test Systems 305 to Distributed Telecommunication Networks 310 is accomplished via the controlled and coordinated application of subsystems 306, 307, 308, and 309.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

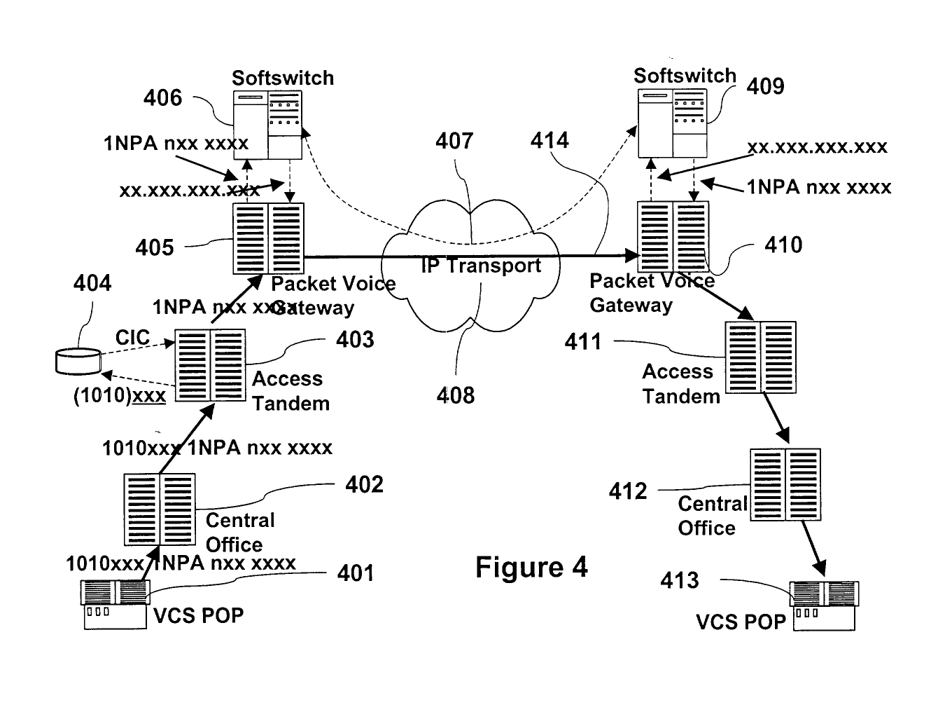

FIGS. 4 to 15 are simplified diagrams various network service applications according to embodiments of the present invention. These diagrams are merely examples, which should not unduly limit the scope of the claims herein. One of ordinary skill in the art would recognize many other variations, modifications, and alternatives. FIG. 4 illustrates an embodiment of the invention monitoring and analyzing the quality of service from end-to-end using a simulation during an active state of a telecommunication network for a 1010xxx calling service. A 1010xxx calling service, otherwise known as “casual calling” allows access to a carriers' service without needing to pre-subscribe. FIG. 4 describes each phase of call progress when establishing and maintaining a connection between originating 401 and terminating 413 VCS Point of Presence Servers.

Upon the Master Controller selecting the VCS Point of Presence Server 401 to initiate a transfer of a selected test pattern, or a series of test patterns, over a specific service (1010xxx service) through the distributed network to one of a plurality of VCS Point of Presence Servers, the VCS Point of Presence Server 401 originating the connection to the service under test goes “off hook” and dials a termination number, which consists of a “1010xxx” plus a one (1), the area code, and phone number (1010xxx-1-NPA-Nxx-xxxx) based upon the simulation set up data (the combination of service access and control parameters and test patterns for transfer as described in detail in the notes for flow chart 101) assigned from the Master Controller.

The dialing instructions (the 1010xxx plus termination number) are then sent to the local Central Office 402 where it is determined that the call is not an intralata, or local, call. From the Central Office the dialing instructions are forwarded to the Access Tandem 403 where the 1010xxx is crosschecked with the Access Tandem CIC database 404 to determine what the appropriate Carrier Identification Code (CIC) is so that the call can be sent to the correct long distance carrier.

Once the appropriate CIC 404 has been determined, the dialing information is sent to the carrier. The carrier's Packet Voice Gateway 405 will send the dialing instructions onto the Softswitch 406 which will translate the dialed number into an IP address that will determine which Packet Voice Gateway to send the packetized test pattern to once the connection has been established. This IP address information will be relayed using one of a plurality of control protocols to communicate with the Softswitch 409 controlling the far end Packet Voice Gateway 410 via a TCP/IP stream 407 over the Carrier's IP Transport network 408. The Softswitch 409 will then translate the terminating IP address back into a standard telephone number and send the call to the local Access tandem 411 via the Packet Voice Gateway 410. Here the Access Tandem 411 will determine to which Central Office 412 the call should be sent for termination.

The Central Office 412 will then determine where to send a ring signal based upon the last 7 digits of the termination number dialed by the originating VCS Point of Presence Server 401. Assuming there is no obstruction on the distributed network as outline above 401-412, the terminating VCS Point of Presence Server 413 will receive a “ring signal” from the Central Office 412. The VCS Point of Presence Server 413 will “answer” the call and the connection will be made. Once the call has been connected the VCS Point of Presence Server 401 will select test patterns, from a plurality of test patterns that are optimized to simulate human voices. After VCS Point of Presence Servers 401 and 413 complete any necessary synchronization procedures needed for the selected test patterns that will be transferred, Point of Presence Server 401 will transfer the selected test patterns to Point of Presence Server 413 to identify a quality level of the distributed telecommunication network between the one Point of Presence Server 401 and the other Point of Presence Server 413. The path taken will be similar to that described above, with the test patterns being generated by the VCS Point of Presence Server 401, the call will pass to the Central office 402 then the Access Tandem 403 and is forwarded onto the carrier's Packet Voice Gateway 405 where the test pattern is converted from a standard analog signal into digitized packets to be sent across the carrier's IP Transport network 408 using the RTP/IP data transport protocol. The digitized test pattern then flows over the RTP/IP stream 414 to Packet Voice Gateway 410. When the packetized test pattern exits the Packet Voice Gateway 410 it gets translated back into an analog signal from it's digitized form. The call is then sent through the Access Tandem 411 through the Central Office 412 and finally to the VCS Point of Presence Server 413.

When a selected or all selected test patterns have been transferred in the first direction from Point of Presence Server 401 to Point of Presence Server 413, the two Point of Presence Servers will communicate and cause the transfer of test patterns in the opposite direction, from Point of Presence Server 413 to Point of Presence Server 401 in the opposite direction to the first direction to form full duplex operation.

This process continues until full duplex testing is complete and the VCS Point of Presence Servers 401 and 413 will go back “on hook,” thereby disconnecting from the service under test. The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

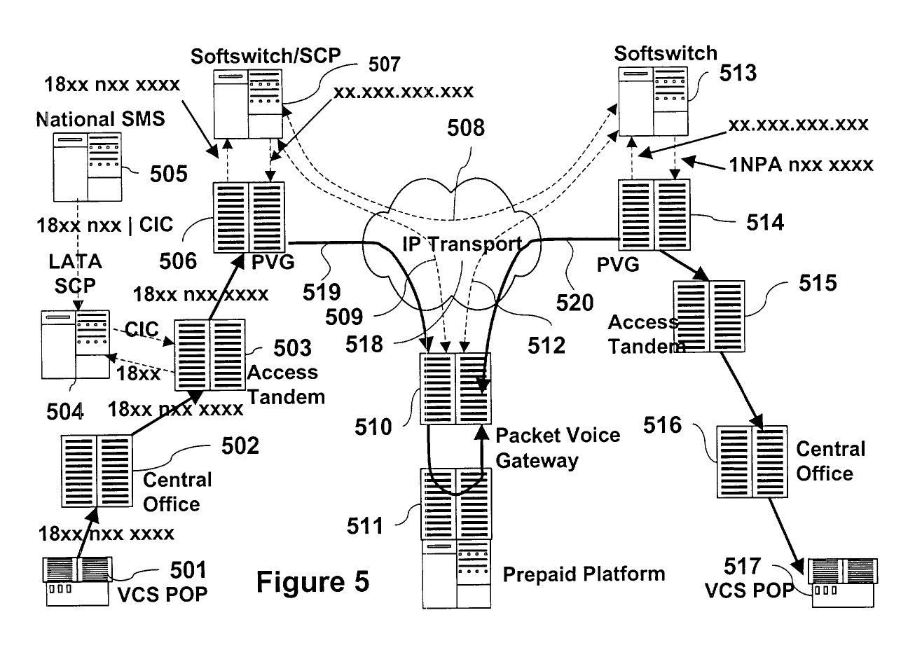

FIG. 5 illustrates an embodiment of the invention monitoring and analyzing the quality of service from end-to-end using a simulation during an active state of a telecommunication network for a Prepaid Calling Card service. A Prepaid Calling Card *service allows usage of a carriers' telecommunications network from any telephone on the public network by dialing a direct access number (usually a toll free 8xx number) and inputting the Prepaid Calling Card account information. Usage of the carriers' Network is limited based upon the amount of time purchased prior to usage or remaining if the account has been used before. FIG. 5 describes each phase of call progress when establishing and maintaining a connection between originating 501 and terminating 517 VCS Point of Presence Servers.

Upon the Master Controller selecting the VCS Point of Presence Server 501 to initiate a transfer of a selected test pattern, or a series of test patterns, over a specific service (Prepaid Calling Card service) through the distributed network to one or a plurality of VCS Point of Presence Servers, the VCS Point of Presence Server 501 that originates the simulated test pattern goes “off hook” and dials an Access Number, which is usually, but not exclusively a toll-free 8xx number (as illustrated in the figure) based upon the simulation set up data assigned from the Master Controller.

The dialing instructions (the 1-8xx-nxx-xxxx) are then sent to the local Central Office 502 where it is determined that the number dialed is not an Intrala, or local, call. From the Central Office 502 the dialing instructions are forwarded to the Access Tandem 503 where it is determined that the number dialed is a 1-8xx-nxx-xxxx number should be crosschecked with the LATA SCP (Service Control Point) database 504 to determine what the appropriate Carrier Identification Code (CIC) is so that the call can be sent to the correct carrier.

The National SMS (Service Management System) 505 is where the Master 8xx-carrier database is updated and maintained. The National SMS 505 will regularly provide data feeds to update the local, or LATA, SCPs 504. When the Access Tandem 503 queries the LATA SCP 504 with the 8xx number dialed by the VCS Point of Presence Server 501, the LATA SCP 504 will check it's most current records provided by the National SMS 505, and send the appropriate CIC (Carrier Identification Code) back.

Once the appropriate CIC 504 has been determined, the call will be sent to the Packet Voice Gateway 506 of the carrier that was designated by the CIC 504. The carriers Softswitch/SCP 507 will determine the appropriate platform to send the call based upon the original number dialed by the VCS Point of Presence Server 501. The carriers' Softswitch/SCP 507 will relay the appropriate IP address for the Prepaid platform-controlling Gateway 510 and signal the gateway of the incoming call via TCP/IP stream 509. The call will then be connected across the carrier's IP Transport network 520, using the RTP/IP data transport protocol, to the carriers' centralized Packet Voice Gateway 510 via RTP/IP stream 518 and from there to the carriers Prepaid Platform 511 which prompts the caller, in this embodiment the VCS Point of Presence Server 501, for specific information regarding the prepaid calling card call being requested. This information usually, but not exclusively, consists of the account number and the number being dialed.

When this information is gathered and the account has been verified on the Prepaid Platform 511 the prepaid platform will dial the terminating number assigned to VCS Point of Presence Server 517. The carrier's Packet Voice Gateway 506 will send the dialing instructions onto the Softswitch 507 which will translate the dialed number into an IP address that will determine which Packet Voice Gateway to send the packetized test pattern to once the connection has been established. This IP address information will be relayed using one of a plurality of control protocols to communicate with the Softswitch 513 controlling the far end Packet Voice Gateway 514 via a TCP/IP stream 508 over the Carrier's IP Transport network 518.

The Softswitch 513 will then translate the terminating IP address into the standard telephone number that was input by the VCS Point of Presence Server 501 and received by the Prepaid Platform 511 and will send the call to the local Access tandem 515 via the Packet Voice Gateway 514. Here the Access Tandem 515 will determine to which Central Office 516 the call should be sent for termination.

The Central Office 516 will then determine where to send a ring signal based upon the last 7 digits of the termination number dialed by the VCS Point of Presence Server 501. Assuming there is no obstruction on the distributed network, as outlined above 502-516, the terminating VCS Point of Presence Server 517 will receive a “ring signal” from the Central Office 516. The VCS Point of Presence Server 517 will “answer” the call and the connection will be made.

Once the call has been connected the VCS Point of Presence Server 501 will select test patterns, from a plurality of test patterns that are optimized to simulate human voices. After VCS Point of Presence Servers 501 and 517 complete any necessary synchronization procedures needed for the selected test patterns that will be transferred, Point of Presence Server 501 will transfer the selected test patterns to Point of Presence Server 517 to identify a quality level of the distributed telecommunication network between the one Point of Presence Server 501 and the other Point of Presence Server 517. The path taken will be the similar to that described above, with the test patterns being generated by the VCS Point of Presence Server 501, the call will pass to the Central office 502 then the Access Tandem 503 and is forwarded onto the carriers Packet Voice Gateway 506 where the test pattern is converted from a standard analog signal into digitized packets to be sent across the carrier's IP Transport network 518 using the RTP/IP data transport protocol. The digitized test pattern then flows over the RTP/IP stream 519 to Packet Voice Gateway 510. At Packet Voice Gateway 510 the test pattern flows into, and out of, Prepaid Platform 511 returning into Packet Voice Gateway 510. The digitized test pattern then flows over the RTP/IP stream 520 to Packet Voice Gateway 514. When the packetized test pattern exits the Packet Voice Gateway 514 it gets translated back into an analog signal from it's digitized form. The call is then sent through the Access Tandem 515 through the Central Office 516 and finally to the VCS Point of Presence Server 517.

When a selected or all selected test patterns have been transferred in the first direction from Point of Presence Server 501 to Point of Presence Server 517, the two Point of Presence Servers will communicate and cause the transfer of test patterns in the opposite direction, from Point of Presence Server 517 to Point of Presence Server 501 in the opposite direction to the first direction to form full duplex operation. This process continues until testing is complete and the VCS Point of Presence Servers 501 and 517 will go back “on hook, thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

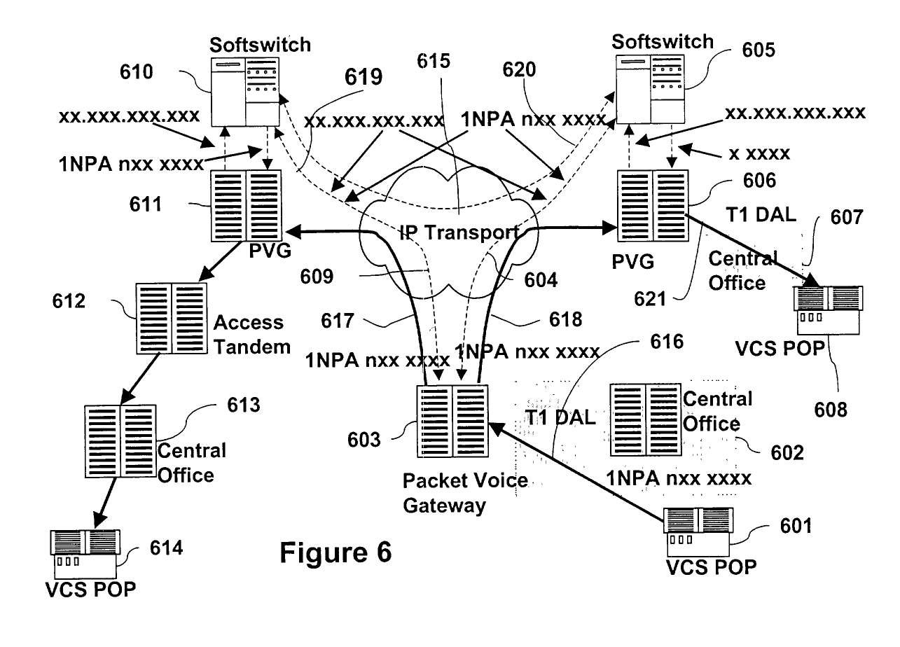

FIG. 6 illustrates an embodiment of the invention monitoring and analyzing the quality of service from end to end using a simulation during an active state of a telecommunication network for a Direct Connect Carrier. A Direct Connect Carrier service consists of an end user establishing a direct connection to the carriers' network via a dedicated connection (i.e. T1, T3, etc) 616 through the local Central office, thereby bypassing the local switch entirely. Therefore the Direct Connect Carrier acts as the end user's long distance carrier for a selected or all voice services directly, without traversing any of the switched access local exchange network. FIG. 6 describes two methods for making calls over the carriers network, to either an on-network or off-network termination, and highlights each phase of call progress when establishing and maintaining a connection between originating 601 and terminating 608 or 614 VCS Point of Presence Servers for both methods. While the service represented in this illustration is a direct dial service (see FIG. 4), the Direct Connect Carrier can offer a plurality of other services, some or all of which can be tested with the Invention as described.

Upon the Master Controller selecting the VCS Point of Presence Server 601 to initiate the transfer of a selected test pattern, or a series of test patterns, over a specific service through the distributed Direct Connect Carrier telecommunications network to one of a plurality of VCS Point of Presence Servers, the VCS Point of Presence Server 601 that originates the connection to the service under test goes “off hook” and dials a Termination Number, which usually, but not exclusively, consists of a 4 to 7 digit phone number from an abbreviated dial plan, called an “on-net number,” as selected by the Master Controller and transmitted to the Point Of Presence Server as part of the simulation set up data (the combination of service access and control parameters and test patterns for selected for transfer).

The dialing instructions (the termination number) are then sent to the Carriers' Packet Voice Gateway 603 via the direct Connection (in this case a T1 DAL 616) through the local Central Office 602. Assuming the call is on network, the carrier's Packet Voice Gateway 603 will send the dialing instructions onto the Softswitch 605, using one of a plurality of control protocols via TCP/IP stream 604, which will translate the dialed number into an IP address that will determine which Packet Voice Gateway to send the packetized test pattern to once the connection has been established.

The Softswitch 605 will then translate the terminating IP address back into a standard telephone number and send the call through the Packet Voice Gateway 606 which will “ring” the far end VCS Point of Presence Server 608 by sending the signal through the dedicated access line 621 through the Central Office 607. The VCS Point of Presence Server 608 will “answer” the call and the connection will be made. Once the call has been connected the VCS Point of Presence Server 601 will select test patterns, from a plurality of test patterns that are optimized to simulate human voices. After VCS Point of Presence Servers 601 and 608 complete any necessary synchronization procedures needed for the selected test patterns that will be transferred, Point of Presence Server 601 will transfer the selected test patterns to Point of Presence Server 608 to identify a quality level of the distributed telecommunication network between the one Point of Presence Server 601 and the other Point of Presence Server 608. The path taken will be the similar to that described above, with the test patterns being generated by the VCS Point of Presence Server 601, the call will pass through the to the Central office 602 via the dedicated access line 616 and is forwarded onto the carriers Packet Voice Gateway 603 where the test pattern is converted from a standard analog signal into digitized packets to be sent across the carrier's IP Transport network 615 using the RTP/IP data transport protocol. The digitized test pattern then flows over the RTP/IP stream 618 to Packet Voice Gateway 606. When the packetized test pattern exits the Packet Voice Gateway 606 it gets translated back into an analog signal from it's digitized form. The call is the sent through the Central office 607 via the dedicated access line 621 and finally to the VCS Point of Presence Server 608.

When some or all selected test patterns have been transferred in the first direction from Point of Presence Server 601 to Point of Presence Server 608, the two Point of Presence Servers will communicate and cause the transfer of test patterns in the opposite direction, from Point of Presence Server 608 to Point of Presence Server 601 in the opposite direction to the first direction to form full duplex operation. This process continues until testing is complete and the VCS Point of Presence Servers 601 and 608 will go back “on hook,” thereby disconnecting from the service under test.

In an off-network method, as represented by FIG. 6, the signaling and call path will be the same but the dialed termination number will be different. In this case the VCS Point of Presence Server 601 that originates connection to the service under test goes “off hook” and dials a Termination Number, which usually, but not exclusively, consists of a “1” plus the area code and phone number (1-NPA-Nxx-xxxx), called an “off-net number” based on the simulation test set up data assigned from the Master Controller. The dialing instructions are sent to the carrier's Packet Voice Gateway 603 will send the dialing instructions onto the Softswitch 610 which will translate the dialed number into an IP address that will determine which Packet Voice Gateway to send the packetized test pattern to once the connection has been established. In this case the Softswitch designate a different Packet Voice Gateway, and hence a different IP address. This IP address information will be relayed using one of a plurality of control protocols to communicate with the Softswitch 610 controlling the far end Packet Voice Gateway 611 via a TCP/IP stream 619 over the Carrier's IP Transport network 615.

The Softswitch 610 will then translate the terminating IP address back into a standard telephone number and send the call to the local Access tandem 612 via Packet Voice Gateway 611. Here the Access Tandem 612 will determine to which Central Office 613 the call should be sent for termination.

The Central Office 613 will then determine where to send a ring signal based upon the 7-digit termination number dialed by the VCS Point of Presence Server 601. Assuming there is no obstruction on the distributed network as outline above 603-613, the terminating VCS Point of Presence Server 614 will receive a “ring signal” from the Central Office 613. The VCS Point of Presence Server 614 will “answer” the call and the connection will be made.

Once the call has been connected the VCS Point of Presence Server 601 will select test patterns, from a plurality of test patterns that are optimized to simulate human voices. After VCS Point of Presence Servers 601 and 614 complete any necessary synchronization procedures needed for the selected test patterns that will be transferred, Point of Presence Server 601 will transfer the selected test patterns to Point of Presence Server 614 to identify a quality level of the distributed telecommunication network between the one Point of Presence Server 601 and the other Point of Presence Server 614. The path taken will be the similar to that described above, with the test patterns being generated by the VCS Point of Presence Server 601, the call will pass through the to the Central office 602 via the dedicated access line 616 and is forwarded onto the carriers Packet Voice Gateway 603 where the test pattern is converted from a standard analog signal into digitized packets to be sent across the carrier's IP Transport network 615 using the RTP/IP data transport protocol. The digitized test pattern then flows over the RTP/IP stream 617 to Packet Voice Gateway 611. When the packetized test pattern exits the Packet Voice Gateway 611 it gets translated back into an analog signal from it's digitized form. The call is then sent through the Access Tandem 612 through the Central Office 613 and finally to the VCS Point of Presence Server 614.

When some or all selected test patterns have been transferred in the first direction from Point of Presence Server 601 to Point of Presence Server 614, the two Point of Presence Servers will communicate and cause the transfer of test patterns in the opposite direction, from Point of Presence Server 614 to Point of Presence Server 601 in the opposite direction to the first direction to form full duplex operation.

This process continues until testing is complete and the VCS Point of Presence Servers 601 and 614 will go back “on hook”, thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

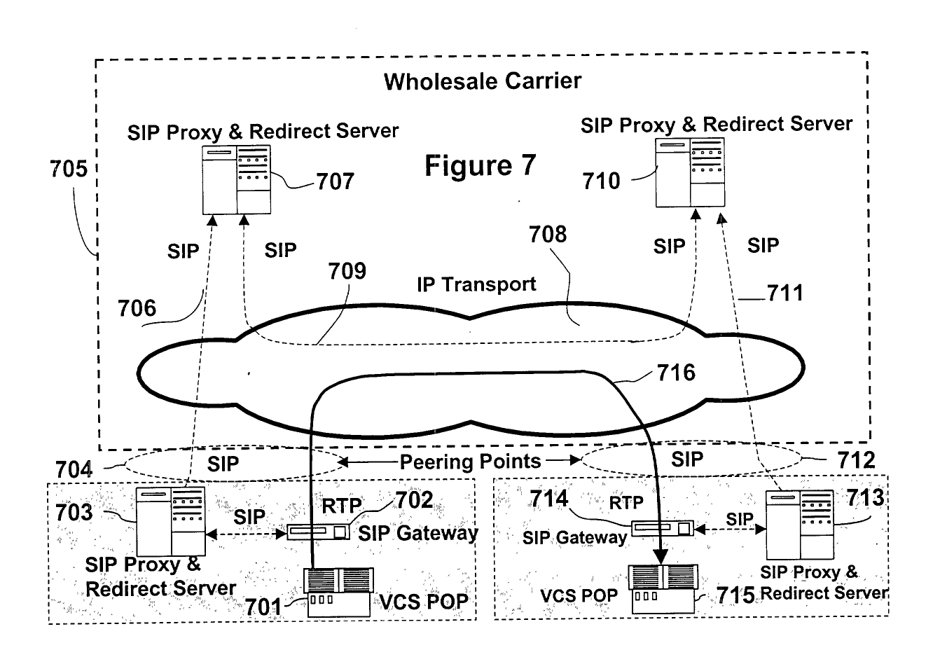

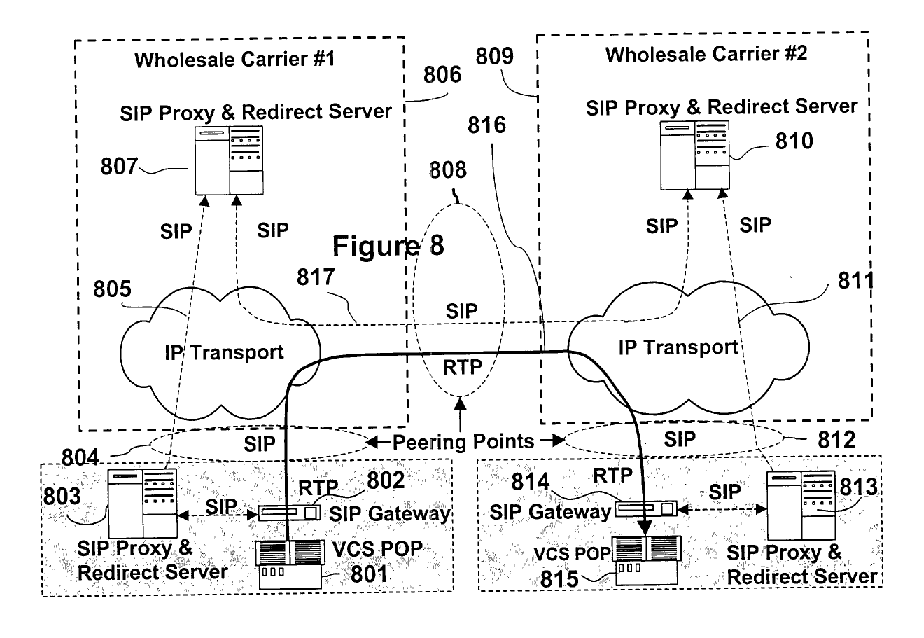

FIG. 7 illustrates an embodiment of the invention monitoring and analyzing the quality of service from end to end using a simulation during an active state of a telecommunication network for a Single-Carrier SIP Interconnect service. The most typical application for this service is one in which a first carrier buys “wholesale” transport and termination service from a second carrier such that the transport of the voice patterns from end users of the first carrier is by VoIP and the signaling for controlling these calls is by Session Initiation Protocol (SIP). The Single-Carrier SIP Interconnect service embodiment of the invention emulates the normal interconnection between carriers by establishing a direct relationship with the SIP carrier's active network by means of SIP Gateways 702 and 714 (serving as User Agent Clients (UAC)), SIP Proxy and Redirect Servers 704 and 713, and VCS Point of Presence Servers 701 and 715 which each emulate a carrier's legacy matrix switch. FIG. 7 highlights each phase of call progress when establishing and maintaining a connection between originating 701 and terminating 715 VCS Point of Presence Servers for two enterprise locations being connected via a SIP network. While the service represented in this illustration is a direct dial service, the SIP Carrier can offer a plurality of other services, some or all of which can be tested with the Invention as described.

Upon the Master Controller selecting the VCS Point of Presence Server 701 to initiate the transfer of a selected test pattern, or a series of test patterns, over a specific service through the distributed SIP Carrier telecommunications network to one of a plurality of VCS Point of Presence Servers, the VCS Point of Presence Server 701 that originates the connection to the service under test goes “off hook” and dials a Termination Number in an emulation of a carrier's legacy matrix switch based upon the simulation set up data received from the Master Controller. The number dialed by the Point of Presence Server 701 will be translated by the SIP systems involved such that the test call will be connected to the Point of Presence Server 715.

Once the VCS Point of Presence Servers 701 initiates the call the SIP Gateway 702 will send the call request to the SIP Proxy and Redirect Server 703 which will forward the request to the Carriers' SIP server 707 using the SIP stream 706 across the Peering point 704 to the Wholesale Carrier's network 705 where it hits the carriers SIP Proxy and Redirect Server 707. The carrier's SIP Proxy and Redirect Server 707 receives the SIP request, strips out the address in the request, checks its address tables for any other addresses that may be mapped to the one in the request, and then forwards the request to the next SIP Proxy and Redirect Server 710 in the network using the SIP stream 709. This SIP Proxy and Redirect Server then in turns sends the signal to the terminating local SIP Proxy and Redirect Server 713 via the SIP stream 711 and the peering point 712 where the request is passed onto the terminating Client gateway 714 while simultaneously sending the client information back to the request originator client gateway 702.

Once the information is returned via the same path it traversed 703-713, the SIP client 702 initiates a call over the IP network 708 directly to the terminating client 715 and the VCS Point of Presence Server 701 will select test patterns, from a plurality of test patterns that are optimized to simulate human voices. After VCS Point of Presence Servers 701 and 715 complete any necessary synchronization procedures needed for the selected test patterns that will be transferred, Point of Presence Server 701 will transfer the selected test patterns to Point of Presence Server 715 to identify a quality level of the distributed telecommunication network between the one Point of Presence Server 701 and the other Point of Presence Server 715. The selected test patterns will be generated by the VCS Point of Presence Server 701 and forwarded into SIP Gateway 702 where the test pattern is converted from a standard analog signal into digitized packets to be sent across the carrier's IP Transport network 708 using the RTP/IP data transport protocol. The digitized test pattern then flows over the RTP/IP stream 716 to SIP Gateway 714. When the packetized test pattern exits the SIP Gateway 714 it gets translated back into an analog signal from it's digitized form.

When some or all selected test patterns have been transferred in the first direction from Point of Presence Server 701 to Point of Presence Server 715, the two Point of Presence Servers will communicate and cause the transfer of test patterns in the opposite direction, from Point of Presence Server 715 to Point of Presence Server 701 in the opposite direction to the first direction to form full duplex operation. This process continues until testing is complete and the VCS Point of Presence Servers 701 and 715 will go back “on hook,” thereby disconnecting from the service under test.

The above figures describe aspects of the invention illustrated by elements in simplified system diagrams. As will be understood by-one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

FIG. 8 illustrates an embodiment of the invention monitoring and analyzing the quality of service from end to end using a simulation during an active state of a telecommunication network for a Multi-Carrier SIP Interconnect service. This service is similar to that described in FIG. 7 for a Single-Carrier SIP Interconnect Service, with the exception that this embodiment shows multiple SIP carriers providing voice transport and termination services over a SIP network. The most typical application for this service is one in which one carrier buys “wholesale” transport and termination service from a second carrier who in turn buys “wholesale” transport and termination from a third carrier and so on for the purpose of which is to enhance the carriers' VoIP transport facilities and presence such that the transport of the voice patterns from end users of the first carrier is by VoIP and the signaling for controlling these calls is by Session Initiation Protocol (SIP). The Multi-Carrier-SIP Interconnect service embodiment of the invention emulates the normal interconnection between carriers by establishing a direct relationship with the SIP carrier's active network by means of SIP Gateways 802 and 814 (serving as User Agent Clients (UAC)), SIP Proxy and Redirect Servers 803 and 813, and VCS Point of Presence Servers 801 and 815 which each emulate a carrier's legacy matrix switch. FIG. 8 highlights each phase of call progress when establishing and maintaining a connection between originating 801 and terminating 815 VCS Point of Presence Servers for two enterprise locations being connected via a SIP network. While the service represented in this illustration is a direct dial service, the SIP Carrier can offer a plurality of other services, some or all of which can be tested with the Invention as described.

Upon the Master Controller selecting the VCS Point of Presence Server 801 to initiate the transfer of a selected test pattern, or a series of test patterns, over a specific service through the distributed SIP Carrier telecommunications network to one of a plurality of VCS Point of Presence Servers, the VCS Point of Presence Server 801 that originates the connection to the service under test goes “off hook” and dials a Termination Number in an emulation of a carrier's legacy matrix switch based upon the simulation set up data received from the Master Controller. The number dialed by the Point of Presence Server 801 will be translated by the SIP systems involved such that the test call will be connected to the Point of Presence Server 815.

Once the VCS Point of Presence Servers 801 initiates the call the SIP Gateway 802 will send the call request to the SIP Proxy and Redirect Server 803 which will forward the request to the first Wholesale Carriers' SIP server 807 using the SIP stream 805 across the Peering point 804 to the first Wholesale Carrier's network 806 where it hits the carrier's SIP Proxy and Redirect Server 807. The first Wholesale Carrier's SIP Proxy and Redirect Server 807 receives the SIP request, strips out the address in the request, checks its address tables for any other addresses that may be mapped to the one in the request, and then forwards the request to the next SIP Proxy and Redirect Server 810 in the network using the SIP stream 817. In this case, the next SIP Proxy and Redirect Server 810 is within the second wholesale carriers' network 809 based upon the physical location of the termination VCS point of Presence Server 815. This SIP Proxy and Redirect Server 810 then in turns sends the signal to the local terminating SIP Proxy and Redirect Server 813 via the SIP stream 811 and the peering point 812 where the request is passed onto the terminating Client gateway 814 while simultaneously sending the client information back to the request originator client gateway 802.

Once the information is returned via the same path it traversed 803-813, the SIP client 802 initiates a call over the IP network 816 directly to the terminating client 814 and the VCS Point of Presence Server 801 will select test patterns, from a plurality of test patterns that are optimized to simulate human voices. After VCS Point of Presence Servers 801 and 815 complete any necessary synchronization procedures needed for the selected test patterns that will be transferred, Point of Presence Server 801 will transfer the selected test patterns to Point of Presence Server 815 to identify a quality level of the distributed telecommunication network between the one Point of Presence Server 801 and the other Point of Presence Server 815. The selected test patterns will be generated by the VCS Point of Presence Server 801 and forwarded into SIP Gateway 802 where the test pattern is converted from a standard analog signal into digitized packets to be sent across the two carriers IP Transport networks using the RTP/IP data transport protocol. The digitized test pattern then flows over the RTP/IP stream 816 to SIP Gateway 814 via Peering Points 804, 808, and 812. When the packetized test pattern exits the SIP Gateway 814 it gets translated back into an analog signal from it's digitized form.

When some or all selected test patterns have been transferred in the first direction from Point of Presence Server 801 to Point of Presence Server 815, the two Point of Presence Servers will communicate and cause the transfer of test patterns in the opposite direction, from Point of Presence Server 815 to Point of Presence Server 801 in the opposite direction to the first direction to form full duplex operation.

This process continues until testing is complete and the VCS Point of Presence Servers 801 and 815 will go back “on hook,” thereby disconnecting from the service under test.

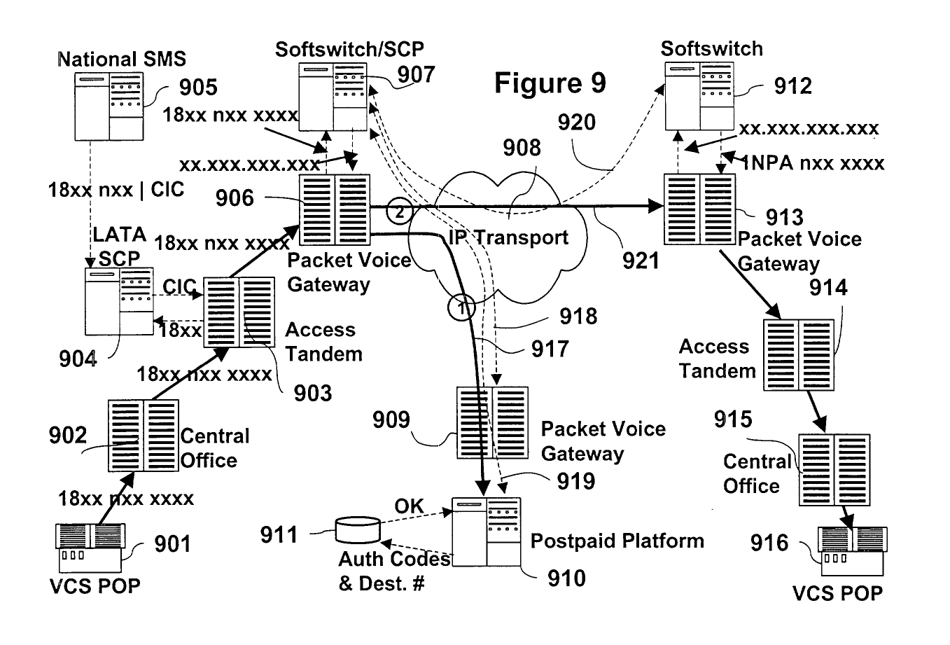

FIG. 9 illustrates an embodiment of the invention monitoring and analyzing the quality of service from end to end using a simulation during an active state of a telecommunication network for a Post-Paid Calling Card with Platform Release service. A Post-paid Calling Card with platform release service allows usage of a carriers' telecommunications network from any telephone on the public network by dialing a direct access number (usually a toll free 8xx number) and inputting the Post-paid Calling Card account information. Billing for usage of the carriers' Network is usually based upon the number of minutes the caller accumulates over a set period of time. The Post-paid platform does not need to check for sufficient funds on the account to complete a call, but will need to verify the active status of the account and any usage restrictions. Hence, the use of the Platform release, which enables the call to flow through the originating Packet Voice Gateway directly rather than occupying a Post-paid Calling Card platform port, as described below. FIG. 9 illustrates each phase of call progress when establishing and maintaining a connection between originating 901 and terminating 916 VCS Point of Presence Servers.

Upon the Master Controller selecting the VCS Point of Presence Server 901 to initiate the transfer of a selected test pattern, or a series of test patterns, over a specific service (Post-paid Calling Card service) through the distributed telecommunications network to one of a plurality of VCS Point of Presence Servers, the VCS Point of Presence Server 901 that originates the connection to the service under test goes “off hook” and dials an Access Number, which is usually, but not exclusively a toll-free 8xx number (as illustrated in FIG. 9) based upon the simulation set up data assigned from the Master Controller.

The dialing instructions (the 1-8xx-nxx-xxxx) are then sent to the local Central Office 902 where it is determined that the number dialed is not an Intra-LATA, or local, call. From the Central Office 902 the dialing instructions are forwarded to the Access Tandem 903 where it is determined that the number dialed is a 1-8xx-nxx-xxxx number and should be crosschecked with the LATA SCP (Service Control Point) database 904 to determine what the appropriate Carrier Identification Code (CIC) is so that the call can be sent to the correct carrier.

The National SMS (Service Management System) 905 is where the Master 8xx-carrier database is maintained. This is where 8xx information is updated and maintained. The National SMS 905 will regularly provide data feeds to update the local, or LATA, SCPs 904. When the Access Tandem 903 queries the LATA SCP 904 with the 8xx number dialed by the VCS Point of Presence Server 901, the LATA SCP 904 will check it's most current records provided by the National SMS 905, and send the appropriate CIC (Carrier Identification Code) back.

Once the appropriate CIC has been determined, the call will be sent to the Packet Voice Gateway 906 of the carrier that was designated by the CIC. The carriers Softswitch/SCP 907 will determine the appropriate platform to send the call based upon the original number dialed by the VCS Point of Presence Server 901. The carriers' Softswitch/SCP 907 will “hold the call” at the originating Packet Voice Gateway 906 while simultaneously relaying the IP address assigned to the Post-paid platform-controlling Packet Voice Gateway 909 and signal the gateway of the incoming call via the one of a plurality of control protocols to communicate with the Packet Voice Gateway 909 over the carrier's IP Transport network 908. The call will then be sent to the carriers' centralized Packet Voice Gateway 909 via the Carriers' IP transport 907 where the carriers Post-paid Platform 910 prompts the caller, in this embodiment the VCS Point of Presence Server 901, for specific information regarding the Post-paid calling card call being requested. This information usually, but not exclusively, consists of the account number, verifying PIN and the number being dialed. The caller, or in this case the VCS Point of Presence Server 901 will send the appropriate information to the Post-paid Platform 910 which then compares the information received with the record in the Post-paid Calling Card Database 911 to usually but not exclusively, confirm the account code and PIN match, the customer status and the availability of the termination number to this specific customer.

Once the account has been verified on the Post-paid Platform 910 the gateway 909 will communicate, via the TCP/IP stream 919, the terminating number back to the originating Softswitch 907 which will in turn determine the appropriate Packet Voice Gateway 913 to send the call to. The IP address of the terminating gateway 913 will be sent to the Originating Packet Voice Gateway 906 and the termination number that was sent to the Originating Softswitch 907 will be sent to the terminating Softswitch 912 for translation using one of a plurality of control protocols via TCP/IP stream 920. Based upon the IP address sent by the Originating Softswitch 907, the call will be released from the originating Packet Voice Gateway 906 and sent to the terminating gateway 913 via the carriers' IP transport 908.

The Softswitch 912 will then translate the terminating IP address into the standard telephone number that was input by the VCS Point of Presence Server 901 and received by the Post-paid Platform 910 and will send the call to the local Access tandem 914 via the Packet Voice Gateway 913. Here the Access Tandem 914 will determine to which Central Office 915 the call should be sent for termination.

The Central Office 915 will then determine where to send a ring signal based upon the last 7 digits of the termination number dialed by the VCS Point of Presence Server 901. Assuming there is no obstruction on the distributed network as outline above 901-915, the terminating VCS Point of Presence Server 916 will receive a “ring signal” from the Central Office 915. The VCS Point of Presence Server 916 will “answer” the call and the connection will be made.

Once the call has been connected the VCS Point of Presence Server 901 will select test patterns, from a plurality of test patterns that are optimized to simulate human voices. After VCS Point of Presence Servers 901 and 916 complete any necessary synchronization procedures needed for the selected test patterns that will be transferred, Point of Presence Server 901 will transfer the selected test patterns to Point of Presence Server 916 to identify a quality level of the distributed telecommunication network between the one Point of Presence Server 901 and the other Point of Presence Server 916. The path taken will be similar to that described above, with the test patterns being generated by the VCS Point of Presence Server 901, the call will pass to the Central Office 902 then the Access Tandem 903 and is forwarded onto the carriers Packet Voice Gateway 906 where the test pattern is converted from a standard analog signal into digitized packets to be sent across the carrier's IP Transport network 908 using the RTP/IP data transport protocol. The digitized test pattern then flows over the RTP/IP stream 921 to Packet Voice Gateway 913. When the packetized test pattern exits the Packet Voice Gateway 906 it gets translated back into an analog signal from it's digitized form. The call is then sent through the Access Tandem 914 through the Central Office 915 and finally to the VCS Point of Presence Server 916.

When some or all selected test patterns have been transferred in the first direction from Point of Presence Server 901 to Point of Presence Server 916, the two Point of Presence Servers will communicate and cause the transfer of test patterns in the opposite direction, from Point of Presence Server 916 to Point of Presence Server 901 in the opposite direction to the first direction to form full duplex operation. This process continues until testing is complete and the VCS Point of Presence Servers 901 and 916 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

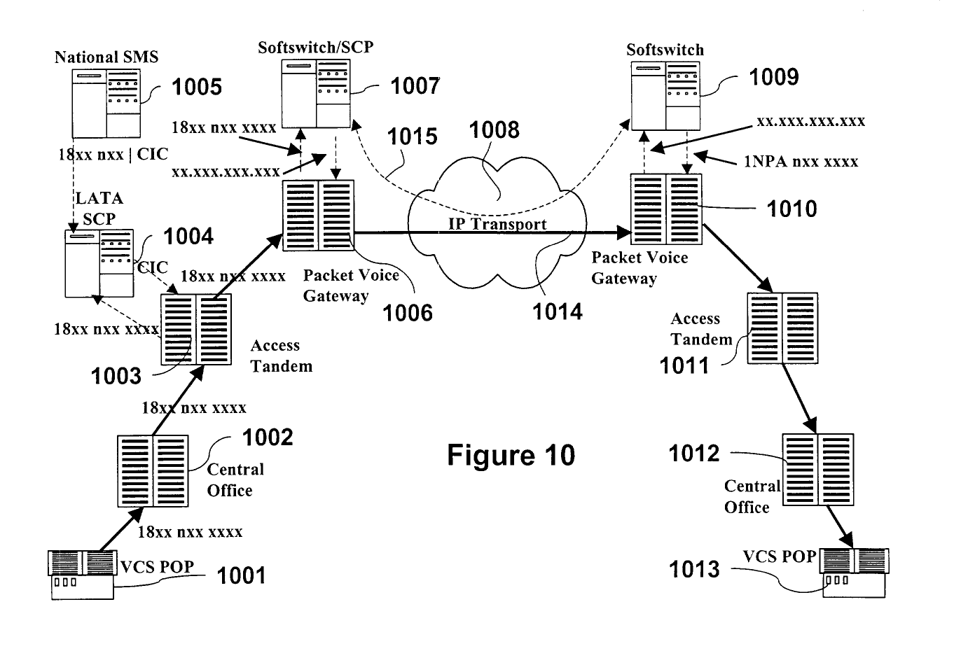

FIG. 10 illustrates an embodiment of the invention monitoring and analyzing the quality of service from end to end using a simulation during an active state of a telecommunication network for an Inward Dialing service. Sometimes called Translation Services, an Inward Dialing service allows usage of a carriers' telecommunications network from any telephone on the public network by dialing a direct access number (usually a toll free 8xx number) that uniquely points to (or translates into) the termination number. FIG. 10 describes each phase of call progress when establishing and maintaining a connection between originating 1001 and terminating 1013 VCS Point of Presence Servers.

Upon the Master Controller selecting the VCS Point of Presence Server 1001 to initiate the transfer of a selected test pattern, or a series of test patterns, over a specific service (Inward Dialing service) through the distributed telecommunications network to one of a plurality of VCS Point of Presence Servers, the VCS Point of Presence Server 1001 that originates the connection to the service under test goes “off hook” and dials an Access/termination number, which is usually, but not exclusively a toll-free 8xx number (as illustrated in FIG. 10) based upon the simulation set up data assigned from the Master Controller.

The dialing instructions (the 1-8xx-nxx-xxxx) are then sent to the local Central Office 1002 where it is determined that the number dialed is not an Intralata, or local, call. From the Central Office 1002 the dialing instructions are forwarded to the Access Tandem 1003 where it is determined that the number dialed is a 1-8xx-nxx-xxxx number and should be crosschecked with the LATA SCP (Service Control Point) database 1004 to determine what the appropriate Carrier Identification Code (CIC) is so that the call can be sent to the correct carrier.

The National SMS (Service Management System) 1005 is where the Master 8xx-carrier database is maintained. This is where 8xx information is updated and maintained. The National SMS 1005 will regularly provide data feeds to update the local, or LATA, SCPs 1004. When the Access Tandem 1003 queries the LATA SCP 1004 with the 8xx number dialed by the VCS Point of Presence Server 1001, the LATA SCP 1004 will check it's most current records provided by the National SMS 1005, and send the appropriate CIC (Carrier Identification Code) back.

Once the appropriate CIC has been determined, the call will be sent to the Packet Voice Gateway 1006 of the carrier that was designated by the CIC. The carrier's Packet Voice Gateway 1006 will send the dialing instructions onto the Softswitch 1007 which will translate the dialed number into an IP address that will determine which Packet Voice Gateway to send the packetized test pattern to once the connection has been established. This IP address information will be relayed using one of a plurality of control protocols to communicate with the Softswitch 1009 controlling the far end Packet Voice Gateway 1010 via a TCP/IP stream 1015 over the Carrier's IP Transport network 1008.

The Softswitch 1009 will then translate the terminating IP address back into a standard telephone number and send the call to the local Access tandem 1011 via Packet Voice Gateway 1010. Here the Access Tandem 1011 will determine to which Central Office 1012 the call should be sent for termination.

The Central Office 1012 will then determine where to send a ring signal based upon the last 7 digits of the termination number sent by the customer's Softswitch 1009 via the Packet Voice Gateway 1010 which was translated directly from the termination number dialed by the VCS Point of Presence Server 1001. Assuming there is no obstruction on the distributed network as outline above 1001-1012, the terminating VCS Point of Presence Server 1013 will receive a “ring signal” from the Central Office 1012. The VCS Point of Presence Server 1013 will “answer” the call and the connection will be made.

Once the call has been connected the VCS Point of Presence Server 1001 will select test patterns, from a plurality of test patterns that are optimized to simulate human voices. After VCS Point of Presence Servers 1001 and 1013 complete any necessary synchronization procedures needed for the selected test patterns that will be transferred, Point of Presence Server 1001 will transfer the selected test patterns to Point of Presence Server 1013 to identify a quality level of the distributed telecommunication network between the one Point of Presence Server 1001 and the other Point of Presence Server 1013. The path taken will be similar to that described above, with the simulated voice being generated by the VCS Point of Presence Server 1001, the call will pass to the Central office 1002 then the Access Tandem 1003 and is forwarded onto the carriers Packet Voice Gateway 1006 where the test pattern is converted from a standard analog signal into digitized packets to be sent across the carrier's IP Transport network 1008 using the RTP/IP data transport protocol. The digitized test pattern then flows over the RTP/IP stream 1014 to Packet Voice Gateway 1010. When the packetized test pattern exits the Packet Voice Gateway 1010 it gets translated back into an analog signal from it's digitized form. The call is the sent through the Access Tandem 1011 through the Central Office 1012 and finally to the VCS Point of Presence Server 1013.

When some or all selected test patterns have been transferred in the first direction from Point of Presence Server 1001 to Point of Presence Server 1013, the two Point of Presence Servers will communicate and cause the transfer of test patterns in the opposite direction, from Point of Presence Server 1013 to Point of Presence Server 1001 in the opposite direction to the first direction to form full duplex operation.

This process continues until testing is complete and the VCS Point of Presence Servers 1001 and 1013 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

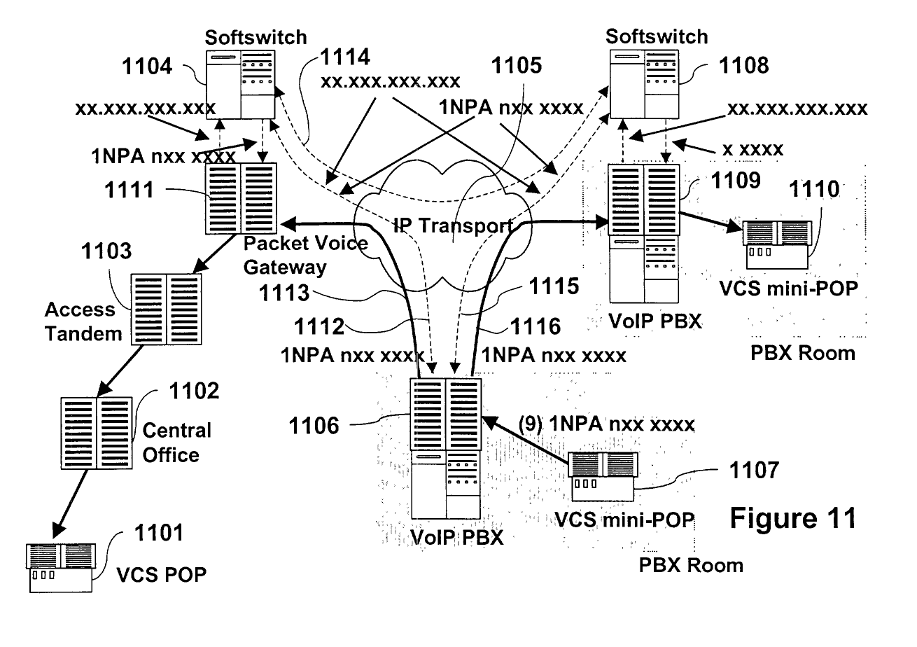

FIG. 11 illustrates an embodiment of the invention monitoring and analyzing the quality of service from end to end using a simulation during an active state of a telecommunication network for a VoIP PBX (Private Branch Exchange) Network with CPE (Customer Premise Equipment). A VoIP PBX Network consists of the enterprise user establishing a connection, on or off network, by passing calls through an on site PBX server 1106 and 1109. The CPE referred to above is in reference to the VCS mini-Points of Presence 1107 and 1110 which are established to enable test calling to one or a plurality of VCS Point of Presence Servers. FIG. 11 describes two methods for making calls over a VoIP PBX Network, to either an on-network or an off-network termination, and highlights each phase of call progress when establishing and maintaining a connection between originating 1107 and terminating 1101 or 1110 VCS Point of Presence Servers for both scenarios. While the service represented in this illustration is a direct dial service, the VoIP PBX Network can offer a plurality of other services, some or all of which can be tested with the Invention as described.

VCS mini Point of Presence servers 1107 and 1110 are located within the enterprise network, behind the VoIP PBX in order to simulate a PBX End User when initiating either ran on- or off-net connection.

Upon the Master Controller selecting the VCS mini-Point of Presence Server 1107 (co-located in the enterprises PBX room) to initiate the transfer of a selected test pattern, or a series of test patterns, over a specific service through the distributed VoIP PBX network to one of a plurality of VCS mini-Point of Presence Servers, the VCS mini-Point of Presence Server 1107 that originates the connection to the service under test goes “off hook” and dials a Termination Number, which usually, but not exclusively, consists of a 4 to 7 digit phone number from an abbreviated dial plan, called an “on-net number,” based upon the simulation set up data assigned from by the Master Controller.

The dialing instructions (the termination number) are then sent to the enterprise VoIP PBX 1106, which determines that the call is either on- or off-net. Assuming the call is on network, the enterprise's VoIP PBX 1106, using one of a plurality of control protocols via TCP/IP stream 1115, will send the dialing instructions onto the Softswitch 1105 which will translate the dialed number into an IP address that will determine which VoIP PBX to send the packetized test pattern to once the connection has been established.

The Softswitch 1108 will then translate the terminating IP address back into a standard telephone number, or abbreviated dial plan code, and send the call through the terminating VoIP PBX 1109 which will “ring” the far end VCS mini-Point of Presence Server 1110 which is located in the PBX room of the terminating VoIP PBX 1109.

Once the call has been connected the VCS Point of Presence Server 1101 will select test patterns, from a plurality of test patterns that are optimized to simulate human voices. After VCS mini-Point of Presence Servers 1107 and 1110 complete any necessary synchronization procedures needed for the selected test patterns that will be transferred, mini-Point of Presence Server 1107 will transfer the selected test patterns to mini-Point of Presence Server 1110 to identify a quality level of the distributed telecommunication network between the one mini-Point of Presence Server 1107 and the other mini-Point of Presence Server 1110. The path taken will be similar to that described above, with the test patterns being generated by the VCS Mini-Point of Presence Server 1107, and being forwarded onto the VoIP PBX 1106 where the test pattern is converted from a standard analog signal into digitized packets to be sent across the carrier's IP Transport network 1105 using the RTP/IP data transport protocol. The digitized test pattern then flows over the RTP/IP stream 1116 to VoIP PBX 1109. When the packetized test pattern exits the VoIP PBX 1109 it gets translated back into an analog signal from it's digitized form. The call is sent through the VoIP PBX 1109 and finally to the VCS Mini-Point of Presence Server 1110.

When some or all selected test patterns have been transferred in the first direction from Point of Presence Server 1107 to Point of Presence Server 1110, the two mini-Point of Presence Servers will communicate and cause the transfer of test patterns in the opposite direction, from Point of Presence Server 1110 to Point of Presence Server 1107 in the opposite direction to the first direction to form full duplex operation.

This process continues until testing is complete and the VCS Mini-Point of Presence Servers 1107 and 1110 will go back “on hook,” thereby disconnecting from the service under test.

In an off-network method, as represented by FIG. 11, the signaling and call path will be similar but the dialed termination number will be different and the call will exit the VoIP PBX Network. In this case the VCS mini-Point of Presence Server 1107 that originates the transfer of a selected test pattern goes “off hook” and dials a Termination Number, which usually, but not exclusively, consists of a “1” plus the area code and phone number (1-NPA-Nxx-xxxx), called an “off-net number” based on the simulation test set up data assigned from the Master Controller. The dialing instructions are sent to the VoIP PBX 1106 which determines that the call is either on- or off-net. Assuming the call is off network, the enterprise's VoIP PBX 1106, using one of a plurality of control protocols via TCP/IP stream 1112, will send the dialing instructions onto the Softswitch 1104 which will translate the dialed number into a different IP address that will designate Packet Voice Gateway to send the packetized test pattern to once the connection has been established.

The Softswitch 1104 will then translate the terminating IP address back into a standard telephone number and send the call to the local Access tandem 1103 via Packet Voice Gateway 1111. The Access Tandem 1103 will determine to which Central Office 1102 the call should be sent for termination.

The Central Office 1102 will then determine where to send a ring signal based upon the termination number dialed by the VCS mini-Point of Presence Server 1107. Assuming there is no obstruction on the distributed network as outline above 1107-1102, the terminating VCS Point of Presence Server 1101 will receive a “ring signal” from the Central Office 1102. The VCS Point of Presence Server 1101 will “answer” the call and the connection will be made.

Once the call has been connected the VCS Mini-Point of Presence Server 1107 will select test patterns, from a plurality of test patterns that are optimized to simulate human voices. After VCS mini-Point of Presence Server 1107 and VCS Point of Presence Server 1101 complete any necessary synchronization procedures needed for the selected test patterns that will be transferred, mini-Point of Presence Server 1107 will transfer the selected test patterns to VCS Point of Presence Server 1101 to identify a quality level of the distributed telecommunication network between the one mini-Point of Presence Server 1107 and the other VCS Point of Presence Server 1101. The path taken will be similar to that described above, with the test patterns being generated by the VCS mini-Point of Presence Server 1107, and is forwarded onto the VoIP PBX 1106 where the test pattern is converted from a standard analog signal into digitized packets to be sent across the carrier's IP Transport network 1105 using the RTP/IP data transport protocol. The digitized test pattern then flows over the RTP/IP stream 1113 to Packet Voice Gateway 1111. When the packetized test pattern exits the Voice Gateway 1111 it gets translated back into an analog signal from it's digitized form.

When some or all selected test patterns have been transferred in the first direction from Point of Presence Server 1107 to Point of Presence Server 1101, the two Point of Presence Servers will communicate and cause the transfer of test patterns in the opposite direction to the first direction, from Point of Presence Server 1101 to Point of Presence Server 1107 to form full duplex operation.

This process continues until testing is complete and the VCS Point of Presence Server 1101 and mini-point of presence sever 1107 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

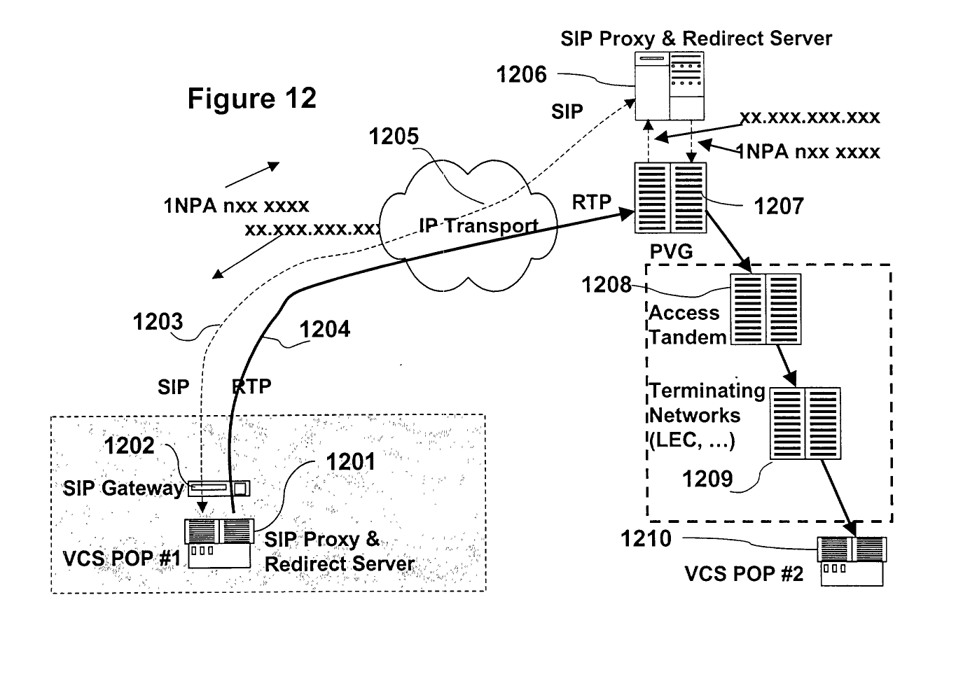

FIG. 12 illustrates an embodiment of the invention monitoring and analyzing the quality of service from end to end using a simulation during an active state of a telecommunication network for a SIP Termination and Terminating Network. This service is similar to that described in FIGS. 7 and 8 for a Single- and Multiple-Carrier SIP Interconnect Services, with exception that this embodiment shows the utilization of a SIP network for termination services. The most typical application for this service is one in which one carrier buys “wholesale” termination service from a second carrier for the purpose of which is to enhance the carriers' VoIP transport facilities and presence such that the transport of the voice patterns from end users of the first carrier is by VoIP and the signaling for controlling these calls is by Session Initiation Protocol (SIP). The SIP Termination and Terminating Network embodiment of the invention emulates the normal interconnection between carriers by establishing a direct relationship with the SIP carrier's active network by means of SIP Gateway 1202 (serving as User Agent Clients (UAC)), SIP Proxy and Redirect Server 1206, and Point of Presence Servers 1201 and 1210 with the former emulating a legacy enterprise telephony network and the latter and standard PSTN. FIG. 12 highlights each phase of call progress when establishing and maintaining a connection between originating 1201 and terminating 1210 VCS Point of Presence Servers for two locations being connected via a SIP network.

Upon the Master Controller selecting the VCS Point of Presence Server 1201 to initiate the transfer of a selected test pattern, or a series of test patterns, over a specific service through the distributed SIP Carrier telecommunications network to one of a plurality of VCS Point of Presence Servers, the VCS Point of Presence Server 1201 that originates the connection to the service under test goes “off hook” and dials a Termination Number, based upon simulation set up data assigned from the Master Controller, in an emulation of a carrier's legacy matrix switch. The number dialed by the Point of Presence Server 1201 will be translated by the SIP systems involved such that the test call will be connected to the Point of Presence Server 1210.

Once the VCS Point of Presence Servers 1201 initiates the call the SIP Gateway 1202 will send the call request to the SIP Proxy and Redirect Server 1206 using the SIP stream 1203 across the IP Transport 1205. The carrier's SIP Proxy and Redirect Server 1206 receives the SIP request, strips out the address in the request, checks its address tables for any other addresses that may be mapped to the one in the request, and then sends the client 1207, in this case a Packet Voice Gateway 1207, information back to the request originator client gateway 1202.

Once the information is returned via the same path it traversed 1202, 1203, and 1206, the SIP client 1202 initiates a call 1204 over the IP network 1205 directly to the terminating client or packet voice gateway 1207 where the voice signal is converted back into an analog signal from it's digitized form. The call is sent through the Access Tandem 1208 through whatever type of terminating network is used 1209 and finally to the VCS Point of Presence Server 1210 where a “Ring Tone” is sent and the call connected.

Once the call has been connected the VCS Point of Presence Server 1201 will select test patterns, from a plurality of test patterns that are optimized to simulate human voices. After VCS Point of Presence Servers 1201 and 1210 complete any necessary synchronization procedures needed for the selected test patterns that will be transferred, Point of Presence Server 1201 will transfer the selected test patterns to Point of Presence Server 1210 to identify a quality level of the distributed telecommunication network between the one Point of Presence Server 1201 and the other Point of Presence Server 1210. The path taken will be similar to that described above, with the test patterns being generated by the VCS Point of Presence Server 1201, the call will pass through the to the SIP Gateway 1202 where the test pattern is converted from a standard analog signal into digitized packets to be sent across the carrier's IP Transport network 1205 using the RTP/IP data transport protocol. The digitized test pattern then flows over the RTP/IP stream 1204 to Packet Voice Gateway 1207. When the packetized test pattern exits the Packet Voice Gateway 1207 it gets translated back into an analog signal from it's digitized form. The call is the sent through the Access Tandem 1208 through whatever type of terminating network is used 1209 and finally to the VCS Point of Presence Server 1210.

When some or all selected test patterns have been transferred in the first direction from Point of Presence Server 1201 to Point of Presence Server 1210, the two Point of Presence Servers will communicate and cause the transfer of test patterns in the opposite direction to the first direction, from Point of Presence Server 1210 to Point of Presence Server 1201 to form full duplex operation.

This process continues until testing is complete and the VCS Point of Presence Servers 1201 and 1210 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

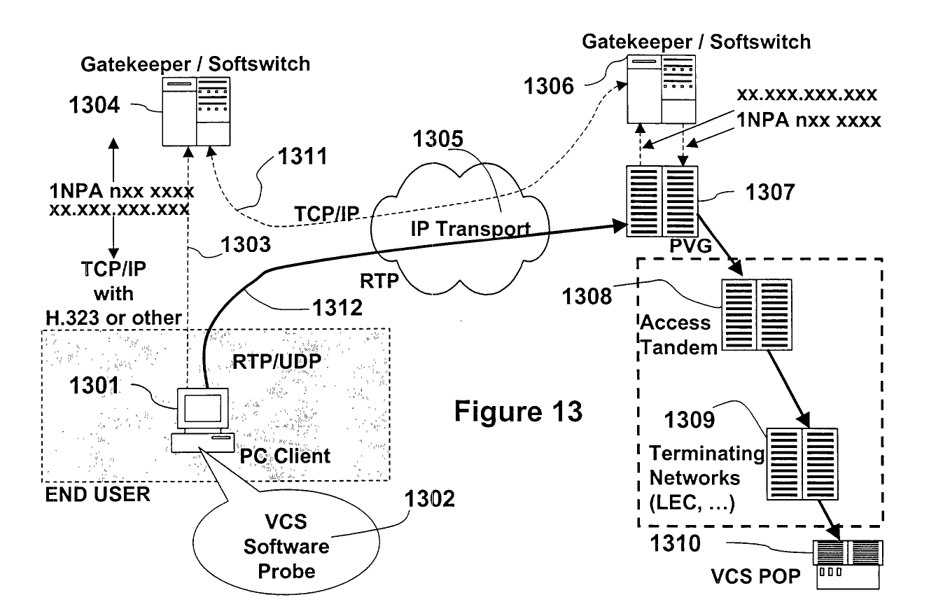

FIG. 13 illustrates an embodiment of the invention monitoring and analyzing the quality of service from end to end using a simulation during an active state of a telecommunication network for a PC to PSTN calling service. PC to PSTN calling services allows users to set up and maintain voice calls using a standard PC to “dial” a PSTN number and connect to the telephone at the far end using a standard Internet connection for the origination portion of the call. In order to test this environment, a “Virtual” VCS Point of Presence server (here called VCS Software Probe 1302) will be installed on the originating PC. This VCS Software Probe is a light version of the standard VCS point of Presence Servers that can be installed on some or all end user PCs as part of, or separately from, the PC's standard installation. FIG. 13 highlights each phase of call progress when establishing and maintaining a connection between originating VCS Software Probe 1302 and terminating VCS Point of Presence Server 1310.

Upon the Master Controller selecting the VCS Software Probe 1302 to initiate the transfer of a selected test pattern, or a series of test patterns, over a specific service (in this case PC to PSTN calling) through the distributed telecommunications network to one of a plurality of VCS Point of Presence Servers, the VCS Software Probe 1302 that originates the connection to the service under test utilizes the PC's 1301 internet connection to go “off hook” and dial a Termination Number which resides on the PSTN network. The number dialed by the PC 1301 based upon the simulation set up data assigned from the Master Controller via the VCS Software Probe 1302 will be sent across the internet connection 1303, via TCP/IP stream using H.323 or some other voice signaling protocol to the carriers' Gatekeeper/Softswitch 1304.

The carrier's Gatekeeper/Softswitch 1304 will translate the dialed number into an IP address that will determine which Packet Voice Gateway 1307 to send the packetized voice call to once the connection has been established. The Gatekeeper/Softswitch will then use one of a plurality of control protocols to communicate with the Gatekeeper/Softswitch 1306 controlling the far end Packet Voice Gateway 1307 via a TCP/IP stream 1311 over the Carriers' IP transport 1305.

The Softswitch 1306 will then translate the terminating IP address back into a standard telephone number and send the call to the local Access Tandem 1308 via the Packet Voice Gateway 1307. Here the Access Tandem 1308 will determine to which Terminating Network 1309 the call should be sent for termination.

The Terminating Network 1309 will then determine where to send a ring signal based upon the last 7 digits of the termination number dialed by the PC 1301 controlled by the VCS Software Probe 1302. Assuming there is no obstruction on the distributed network as outline above 1301-1309, the terminating VCS Point of Presence Server 1310 will receive a “ring signal” from the Terminating Network 1309. The VCS Point of Presence Server 1310 will “answer” the call and the connection will be made.

Once the call has been connected the VCS Software Probe 1302 will select test patterns, from a plurality of test patterns that are optimized to simulate human voices. After VCS Software Probe 1302 and VCS Point of Presence Server 1310 complete any necessary synchronization procedures needed for the selected test patterns that will be transferred, VCS Software Probe 1302 will transfer the selected test patterns to Point of Presence Server 1310 to identify a quality level of the distributed telecommunication network between the one VCS Software Probe 1302 and the Point of Presence Server 1310. The path taken will be similar to that described above. The VCS Software Probe 1302 sends the selected test pattern or patterns though the PC Client 1301 where the test pattern is converted from a standard analog signal into digitized packets to be sent across the carrier's IP Transport network 1305 using the RTP/IP data transport protocol. The digitized test pattern then flows over the RTP/IP stream 1312 to Packet Voice Gateway 1307. When the packetized test pattern exits the Packet Voice Gateway 1307 it gets translated back into an analog signal from it's digitized form. The call is then sent through the Access Tandem 1308 through the Terminating Network 1309 and finally to the VCS Point of Presence Server 1310.

When some or all of the selected test patterns have been transferred in the first direction from VCS Software Probe 1302 to Point of Presence Server 1310, the two Point of Presence Servers will communicate and cause the transfer of test patterns in the opposite direction to the first direction, from Point of Presence Server 1310 to VCS Software Probe 1302 to form full duplex operation.

This process continues until testing is complete and the PC 1301 with the VCS Software Probe 1302 and the far end VCS Point of Presence Server 1310 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

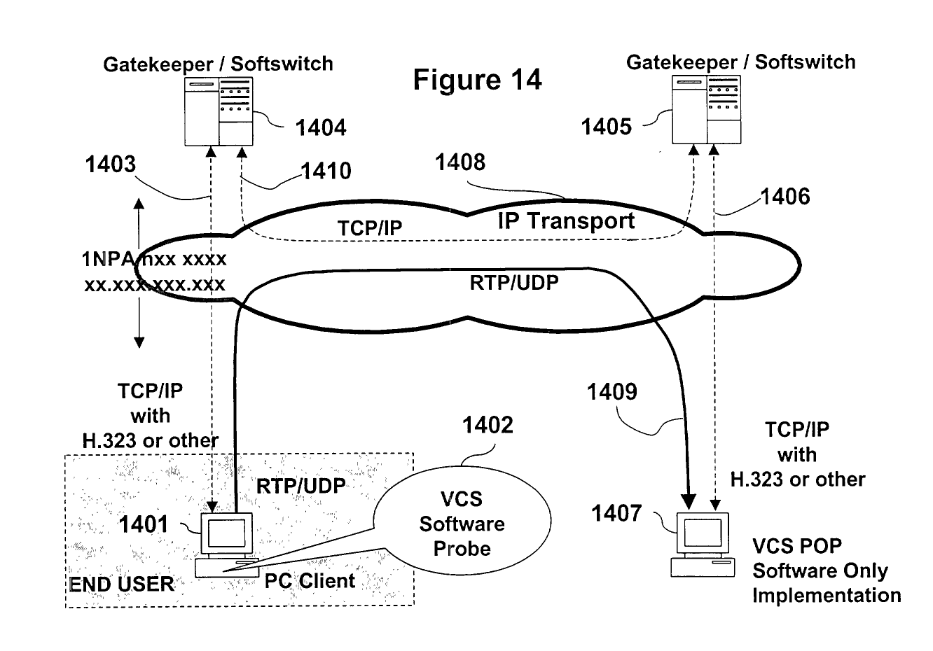

FIG. 14 illustrates an embodiment of the invention monitoring and analyzing the quality of service from end to end using a simulation during an active state of a telecommunication network for a PC-to-PC calling service. PC to PC calling services allows users to set up and maintain voice calls using a standard PC to “dial” another PC, both of which are connected to a public or private network. In order to test this environment, a “Virtual” VCS Point of Presence server (here called VCS Software Probe 1402) will be installed on the originating PC. This VCS Software Probe is a light version of the standard VCS point of Presence Servers that can be installed on some or all end user PCs as part of, or separately from, the PC's standard installation. Additionally, there will be a full capability, but software only implementation of the VCS Point of Presence Server 1407 that will serve as the permanent termination points for these test calls. FIG. 14 highlights each phase of call progress when establishing and maintaining a connection between the end user originating PC 1401 with VCS Software Probe installed and the terminating PC 1407 with the full software implementation installed.

Upon the Master Controller selecting the VCS Software Probe 1402 to initiate the transfer of a selected test pattern, or a series of test patterns, over a specific service (in this case PC to PC calling) through the distributed Carrier telecommunications network to one of a plurality of VCS Software implementations 1407, the VCS Software Probe 1402 that originates the connection to the service under test utilizes the PCs 1401 internet connection to go “off hook” and dial a Termination Number which resides on another PC. The number dialed by the PC 1401 will be either an IP address or some sort of user name or account number that is matched to an IP address in the Carriers' database based upon the simulation set up data assigned from the Master Controller via the VCS Software Probe 1402 will be sent across the internet connection 1403, via TCP/IP stream using H.323 or some other voice signaling protocol to the carrier's Gatekeeper/Softswitch 1404 sometimes referred to as the Gate Keeper.

The carrier's Gatekeeper/Softswitch 1404 will translate the dialing instructions into an IP address if needed and communicate, via TCP/IP stream 1410, with the far end Gatekeeper/Softswitch 1405 to determine the current status of the intended recipient and to complete the signaling path with the TCP/IP stream using H.323 or some other voice signaling protocol 1406. Once the voice path is opened the Gatekeeper/Softswitch 1405 controlling the far end PC will use one of a plurality of control protocols to communicate with the originating Gateway/Softswitch 1404 that the test connection has been established and the channel is available for a call set up. The originating PC 1401 will then establish a voice channel call with the terminating end PC 1407 directly using RTP/UDP data transport protocols.

Once the call has been connected the VCS Software Probe 1402 will select test patterns, from a plurality of test patterns that are optimized to simulate human voices. After VCS Software Probe 1402 and full VCS Software Implementation 1407 complete any necessary synchronization procedures needed for the selected test patterns that will be transferred, VCS Software Probe 1402 will transfer the selected test patterns to full VCS Software Implementation 1407 to identify a quality level of the distributed telecommunication network between the one VCS Software Probe 1402 and the full VCS Software Implementation 1407. The path taken will be, via RTP/IP stream 1409, between the two PCs over the carrier's, and end user's IP Transport connection 1408. The VCS Software Probe 1402 sends the selected test pattern or patterns though the PC Client 1401 where the test pattern is converted from a standard analog signal into digitized packets to be sent across the carrier's IP Transport network 1408 using the RTP/IP data transport protocol. The digitized test pattern then flows over the RTP/IP stream 1409 to full VCS Software Implementation 1407 where it gets translated back into an analog signal from it's digitized form.

When some or all selected test patterns have been transferred in the first direction from VCS Software Probe 1402 to full VCS Software Implementation 1407, the two will communicate and cause the transfer of test patterns in the opposite direction to the first direction, from full VCS Software Implementation 1407 to VCS Software Probe 1402 to form full duplex operation.

This process continues until testing is complete and the PC 1401 with the VCS Software Probe 1402 and the far end PC 1407 with the full VCS Software implementation will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

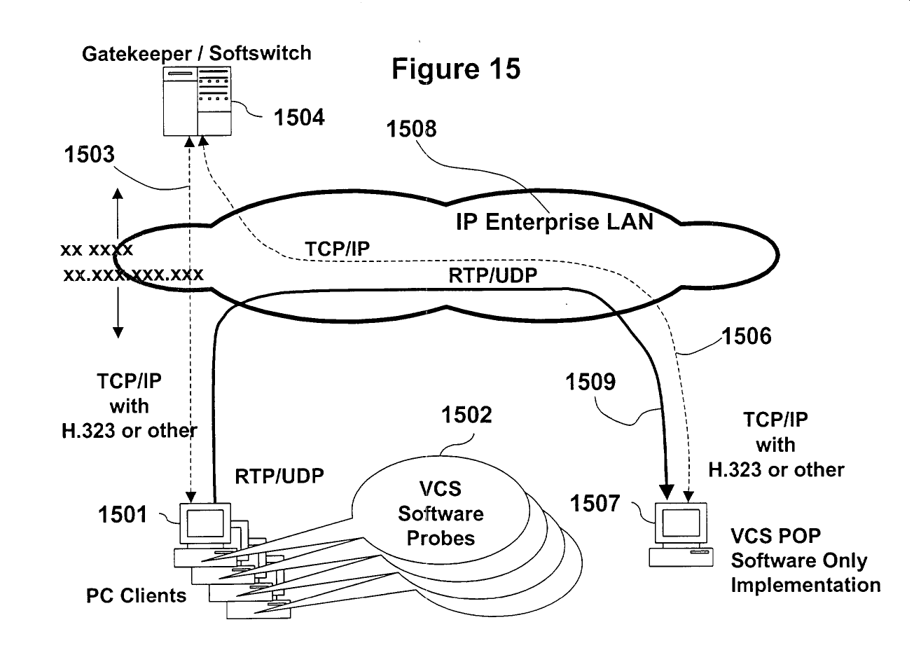

FIG. 15 illustrates an embodiment of the invention monitoring and analyzing the quality of service from end to end using a simulation during an active state of a telecommunication network for a PC-to-PC calling service within an IP Enterprise LAN 1508. PC to PC calling services allows users to set up and maintain voice calls using a standard PC to “dial” another PC, both of which are connected to the IP Enterprise LAN 1508. In order to test this environment, a “Virtual” VCS Point of Presence server (here called VCS Software Probe 1502) will be installed on each of a plurality of originating PCs. This VCS Software Probe is a light version of the standard VCS point of Presence Servers that can be installed on some or all end user PCs as part of, or separately from, the PC's standard installation. Additionally, there will be a full capability, but software only implementation of the VCS Point of Presence Server 1507 that will serve as the permanent termination points for these test calls. FIG. 15 highlights each phase of call progress when establishing and maintaining a connection between the end user originating PC 1501 with VCS Software Probe installed and the terminating PC 1507 with the full software implementation installed.

Upon the Master Controller selecting one of the VCS Software Probe 1502, in the selected customer's enterprise LAN network, to initiate the transfer of a selected test pattern, or a series of test patterns, over a specific service (in this case PC to PC calling) through the IP Enterprise LAN 1508 network to a of VCS Software only implementation 1507, the VCS Software Probe 1502 that originates the connection to the service under test utilizes the PCs 1501 internet connection to go “off hook” and dial a Termination Number which resides on another PC. The number dialed by the PC 1501 will be either an abbreviated dial plan such as an “extension number,” an IP address or some sort of user name or account number that is matched to an IP address in the Carriers' database based upon the simulation set up data assigned from the Master Controller via the VCS Software Probe 1502 will be sent across the internet connection 1503, via TCP/IP stream using H.323 or some other voice signaling protocol to the carrier's Gatekeeper/Softswitch 1504 sometimes referred to as the Gate Keeper.

The Enterprise Gatekeeper/Softswitch 1504 will translate the dialing instructions into an IP address if needed and communicate, via TCP/IP stream 1506, with the far end VCS Point of Presence Server 1507 to determine the current status of the intended recipient and to complete the signaling path with the TCP/IP stream using H.323 or some other voice signaling protocol 1506. Once the voice path is opened the Gatekeeper/Softswitch 1504 controlling the far end PC will use one of a plurality of control protocols to communicate with the originating PC Client 1501 that the test connection has been established and the channel is available for a call set up. The originating PC 1501 will then establish a voice channel call with the terminating end PC 1507 directly using RTP/UDP data transport protocols.

Once the call has been connected the VCS Software Probe 1502 will select test patterns, from a plurality of test patterns that are optimized to simulate human voices. After VCS Software Probe 1502 and full VCS Software Implementation 1507 complete any necessary synchronization procedures needed for the selected test patterns that will be transferred, VCS Software Probe 1502 will transfer the selected test patterns to full VCS Software Implementation 1507 to identify a quality level of the distributed telecommunication network between the one VCS Software Probe 1502 and the full VCS Software Implementation 1507. The path taken will be, via RTP/IP stream 1509, between the two PCs over the Enterprise's LAN 1508. The VCS Software Probe 1502 sends the selected test pattern or patterns though the PC Client 1501 where the test pattern is converted from a standard analog signal into digitized packets to be sent across the carrier's IP Transport network 1508 using the RTP/IP data transport protocol. The digitized test pattern then flows over the RTP/IP stream 1509 to full VCS Software Implementation 1507 where it gets translated back into an analog signal from it's digitized form

When some or all selected test patterns have been transferred in the first direction from VCS Software Probe 1502 to full VCS Software Implementation 1507, the two will communicate and cause the transfer of test patterns in the opposite direction to the first direction, from full VCS Software Implementation 1507 to VCS Software Probe 1502 to form full duplex operation.

This process continues until testing is complete and the PC 1501 with the VCS Software Probe 1502 and the far end PC 1507 with the full VCS Software implementation will go back “on hook,” thereby disconnecting from the service under test.

The above figures describe aspects of the invention illustrated by elements in simplified system diagrams. As will be understood by one of ordinary skill in the” art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

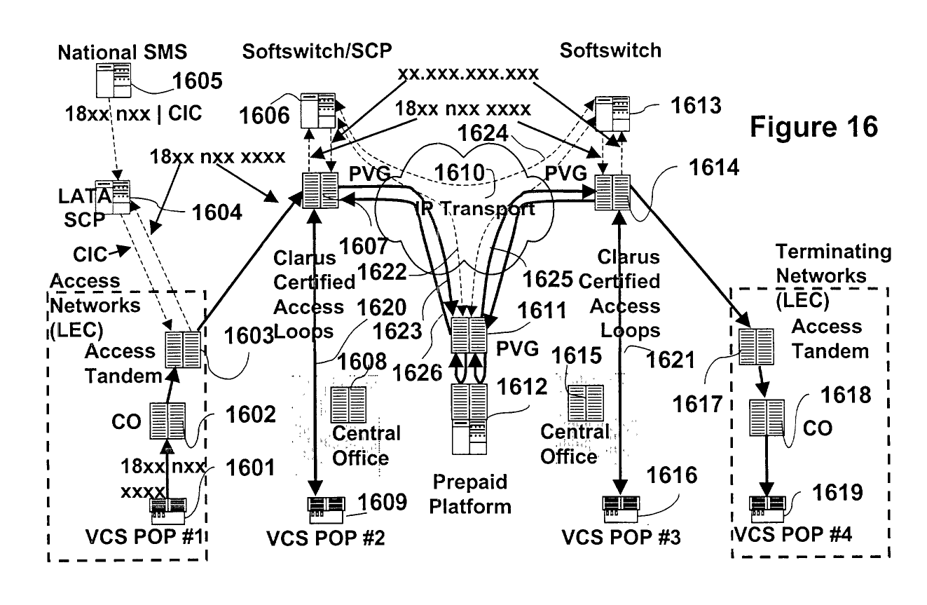

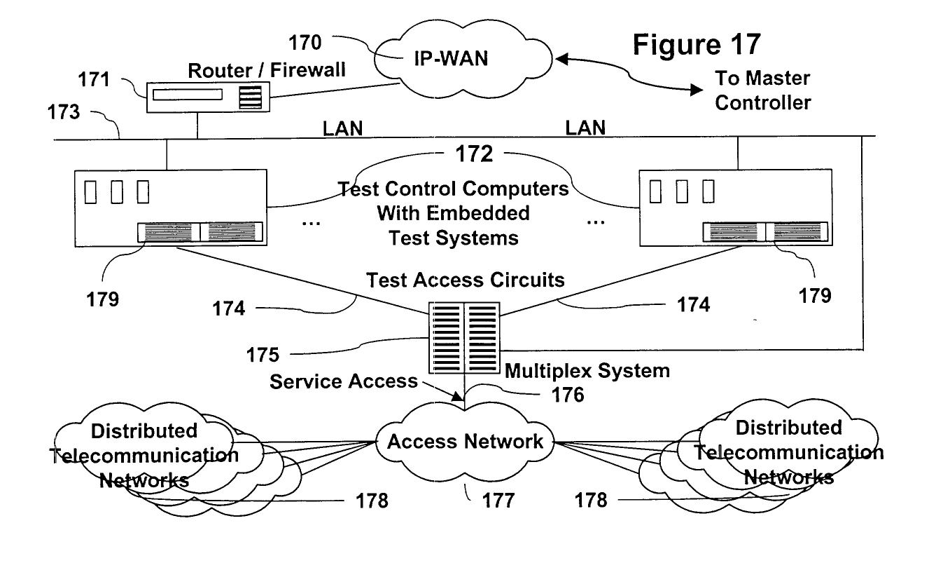

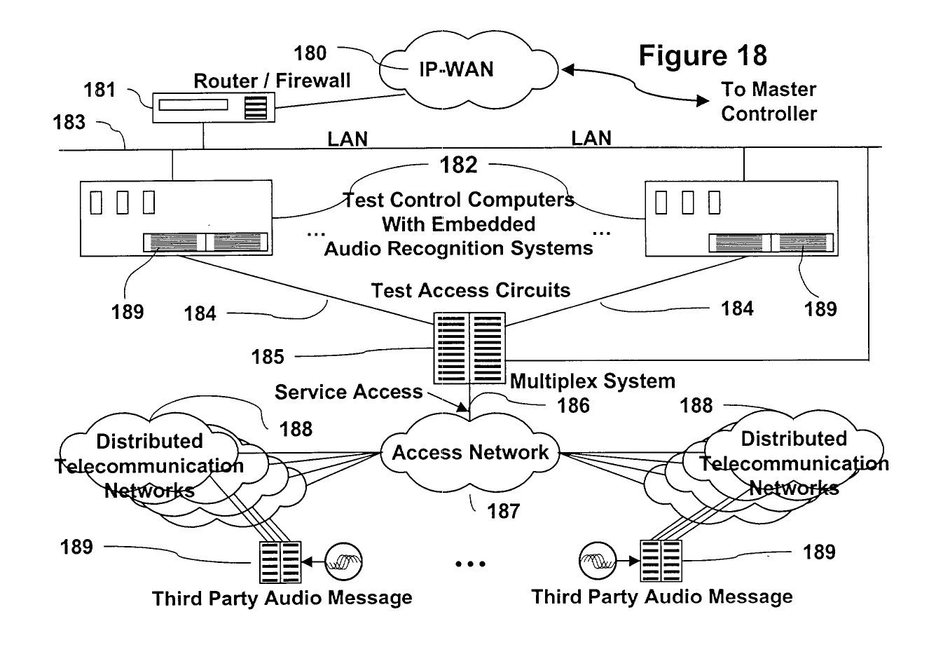

FIG. 16 illustrates an embodiment of the invention monitoring and analyzing the quality of service from end to end as well as showing a plurality of test isolation points using a simulation during an active state of a telecommunication network for a distributed Wholesale IP network using a prepaid paid calling platform. In a wholesale network environment, the IP transport 1610 is typically, but not exclusively, provided by the wholesale carrier, in a distributed telecommunication network, which is capable of providing communications to a plurality of users during an active state, while the other access points, origination and termination, would be provided by other entities. FIG. 16 shows, merely by way of example, an embodiment of a prepaid calling card service being offered in a wholesale network environment. But it will be recognized that the invention can be applied to other products and services that the wholesale provider provides. FIG. 16 highlights each phase of call progress when testing various failure points on a distributed Wholesale network by establishing and maintaining a connection between a plurality originating VCS Point of Presence Servers #1 1601, #2 1609, and #3 1616 and a plurality of terminating VCS Point of Presence Servers including, but not limited to, VCS Point of Presence Servers #2 1609, #3 1616, and #4 1619. When a problem is discovered while testing a similar type of distributed network, the invention will be able to originate test calls from a plurality of VCS Point of Presence Servers (#1 1601, #2 1609, and #3 1616) in order to test various segments of the network, by terminating to a plurality of VCS Point of Presence Servers (#2 1609, #3 1616, and #4 1619), via different routes, as discussed below.

In standard network Testing, the Master Controller will select the VCS Point of Presence Server 1601 to initiate the transfer of a selected test pattern, or a series of test patterns, over a specific service (in this case Prepaid Calling) through the distributed Wholesale Carrier telecommunications network to one of a plurality of VCS Point of Presence Servers 1619, the VCS Point of Presence Server 1601 that originates the connection to the service under test goes “off hook” and dials an Access Number, which is usually, but not exclusively a toll-free 8xx number (as illustrated in FIG. 16) based upon the simulation set up data assigned from the Master Controller.

The dialing instructions (the 1-8xx-nxx-xxxx) are then sent to the local Central Office 1602 where it is determined that the number dialed is not an Intralata, or local, call. From the Central Office 1602 the dialing instructions are forwarded to the Access Tandem 1603 where it is determined that the number dialed is a 1-8xx-nxx-xxxx number should be crosschecked with the LATA SCP (Service Control Point) database 1604 to determine what the appropriate Carrier Identification Code (CIC) is so that the call can be sent to the correct carrier.

The National SMS (Service Management System) 1605 is where the Master 8xx-carrier database is updated and maintained. The National SMS 1605 will regularly provide data feeds to update the local, or LATA, SCPs 1604. When the Access Tandem 1603 queries the LATA SCP 1604 with the 8xx number dialed by the VCS Point of Presence Server 1601, the LATA SCP 1604 will check it's most current records provided by the National SMS 1605, and send the appropriate CIC (Carrier Identification Code) back.

Once the appropriate CIC 1604 has been determined, the call will be sent to the Packet Voice Gateway 1607 of the carrier that was designated by the CIC 1604. The carriers Softswitch/SCP 1606 will determine the appropriate platform to send the call based upon the original number dialed by the VCS Point of Presence Server 1601. The carriers' Softswitch/SCP 1606 will relay the appropriate IP address for the Prepaid platform-controlling Gateway 1611 and signal the gateway of the incoming call via the TCP/IP stream 1622. The call will then be connected across the carrier's IP Transport network 1610, using the RTP/IP data transport protocol, to the carriers' centralized Packet Voice Gateway 1611 via the RTP/IP stream 1623 and from there to the carrier's Prepaid Platform 1612 which then prompts the caller, in this embodiment the VCS Point of Presence Server 1601, for specific information regarding the prepaid calling card call being requested. This information usually, but not exclusively, consists of the account number and the desired termination number.

When this information is gathered and the account has been verified on the Prepaid Platform 1612 the prepaid platform will dial the terminating number assigned to VCS Point of Presence 1619. The carrier's Packet Voice Gateway 1607 will send the dialing instructions onto the Softswitch 1606 which will translate the dialed number into an IP address that will determine which Packet Voice Gateway to send the packetized test pattern to once the connection has been established. This IP address information will be relayed using one of a plurality of control protocols to communicate with the Softswitch 1613 controlling the far end Packet Voice Gateway 1614 via a TCP/IP stream 1624 over the Carrier's IP Transport network 1610.

The Softswitch 1613 will then translate the terminating IP address into the standard telephone number that was input by the VCS Point of Presence Server 1601 and received by the Prepaid Platform 1612 and will send the call to the local Access tandem 1617 via the Packet Voice Gateway 1614. Here the Access Tandem 1617 will determine to which Central Office 1618 the call should be sent for termination.

The Central Office 1618 will then determine where to send a ring signal based upon the last 7 digits of the termination number dialed by the VCS Point of Presence Server 1601. Assuming there is no obstruction on the distributed network, as outlined above 1602-1618, the terminating VCS Point of Presence Server 1619 will receive a “ring signal” from the Central Office 1618. The VCS Point of Presence Server 1619 will “answer” the call and the connection will be made.

Once the call has been connected the VCS Point of Presence Server 1601 will select test patterns, from a plurality of test patterns that are optimized to simulate human voices. After VCS Point of Presence Servers 1601 and 1619 complete any necessary synchronization procedures needed for the selected test patterns that will be transferred, Point of Presence Server 1601 will transfer the selected test patterns to Point of Presence Server 1619 to identify a quality level of the distributed telecommunication network between the one Point of Presence Server 1601 and the other Point of Presence Server 1619. The path taken will be similar to that described above, with the test patterns being generated by the VCS Point of Presence Server 1601, the call will pass to the Central Office 1602 then the Access Tandem 1603 and is forwarded onto the carriers Packet Voice Gateway 1607 where the test pattern is converted from a standard analog signal into digitized packets to be sent across the carrier's IP Transport network 1610 using the RTP/IP data transport protocol. The digitized test pattern then flows over the RTP/IP stream 1623 to Packet Voice Gateway 1611. At Packet Voice Gateway 1611 the test pattern flows into, and out of, Prepaid Platform 1612 returning into Packet Voice Gateway 1611. The digitized test pattern then flows over the RTP/IP stream 1625 to Packet Voice Gateway 1614. When the packetized test pattern exits the Packet Voice Gateway 1614 it gets translated back into an analog signal from it's digitized form. The call is then sent through the Access Tandem 1617 through the Central Office 1618 and finally to the VCS Point of Presence Server 1619.

When some or all selected test patterns have been transferred in the first direction from Point of Presence Server 1601 to Point of Presence Server 1619, the two Point of Presence Servers will communicate and cause the transfer of test patterns in the opposite direction to the first direction, from Point of Presence Server 1619 to Point of Presence Server 1601 to form full duplex operation.

This process continues until testing is complete and the VCS Point of Presence Servers 1601 and 1619 will go back “on hook,” thereby disconnecting from the service under test.

Upon the conclusion of the test, various faults or failures may be discovered that will need to be isolated. These faults or failures include, but are not limited to, poor clarity or availability issues. In order to isolate these faults or failures, the invention will be able to isolate various parts of the wholesale network in order to test in isolation.

In testing for access reliability and/or quality of service of the access provider's service, the Master Controller will select the VCS Point of Presence Server 1601 to initiate the transfer of a selected test pattern, or a series of test patterns, over a specific route or segment of a route through the distributed Wholesale Carrier telecommunications network to one of a plurality of VCS Point of Presence Servers 1609, the VCS Point of Presence Server 1601 that originates the connection to the service under test goes “off hook” and dials an Access Number, which is usually, but not exclusively a toll-free 8xx number (as illustrated in FIG. 16) based upon the simulation set up data assigned from the Master Controller. This access number will differ from the one described above when testing end to end, in order to route the testing pattern to the appropriate VCS Point of Presence Server 1609.

Just as described above, the dialing instructions (the 1-8xx-nxx-xxxx) are then sent through the local Central Office 1602, the Access Tandem 1603, to the LATA SCP (Service Control Point) database 1604 to determine what the appropriate Carrier Identification Code (CIC), and finally into the Packet Voice Gateway 1607 of the carrier that was designated by the CIC 1604.

Once the call reaches the carriers' Voice Packet Gateway 1607 the carriers Softswitch/SCP 1606 will determine the appropriate platform to send the call based upon the original number dialed by the VCS Point of Presence Server 1601. In this case the call will be routed directly to the VCS Point of Presence Server #2 1609, which is connected directly to the wholesale carriers network through the local Central Office 1608 via a Clarus Certified Access Loop 1620. The carriers' Softswitch/SCP 1606 will relay the appropriate IP address for the VCS Point of Presence Server #2 1609 and, assuming there is no obstruction on the access portion of the distributed network as outline above 1602-1607, the terminating VCS Point of Presence Server 1609 will receive a “ring signal” from the Voice Packet Gateway 1607. The VCS Point of Presence Server 1609 will “answer” the call and the connection will be made.

Once the call has been connected the VCS Point of Presence Server 1601 will select test patterns, from a plurality of test patterns that are optimized to simulate human voices. After VCS Point of Presence Servers 1601 and 1609 complete any necessary synchronization procedures needed for the selected test patterns that will be transferred, Point of Presence Server 1601 will transfer the selected test patterns to Point of Presence Server 1609 to identify a quality level of the distributed telecommunication network between the one Point of Presence Server 1601 and the other Point of Presence Server 1609, thereby measuring the quality of service provided from the access provider perspective alone. The path taken will be similar to that described above, with the test patterns being generated by the VCS Point of Presence Server 1601, the call will pass to the Central Office 1602 then the Access Tandem 1603 and forwarded onto the carriers Packet Voice Gateway 1607 where the call will be sent directly to the VCS Point of Presence Server #2 1609 for termination. While traversing Packet Voice Gateway 1607 the test patterns will be converted from analog signal from to digitized packet form and back to analog signal form.

When some or all selected test patterns have been transferred in the first direction from Point of Presence Server 1601 to Point of Presence Server 1609, the two Point of Presence Servers will communicate and cause the transfer of test patterns in the opposite direction to the first direction, from Point of Presence Server 1609 to Point of Presence Server 1601 to form full duplex operation.

This process continues until testing is complete and the VCS Point of Presence Servers 1601 and 1609 will go back “on hook,” thereby disconnecting from the service under test.

The Master Controller may also initiate a simulated test pattern, or a series of test patterns, in order to isolate a specific service platform (in this case Prepaid Calling) 1612 through the distributed Wholesale Carrier network to one or a plurality of VCS Point of Presence Servers 1609 or 1616.

In this embodiment, designed to isolate the service platform, the Master Controller will select the VCS Point of Presence Server 1609 to initiate the transfer of a selected test pattern, or a series of test patterns, over a specific service platform (in this case Prepaid Calling) through the distributed Wholesale Carrier telecommunications network so that the call will be connected to itself, VCS Point of Presence Servers 1609. The VCS Point of Presence Server 1609 that originates the connection to the service under test then goes “off hook” and connects to the carriers Packet Voice Gateway 1607 and dials an Access Number, which is usually, but not exclusively a toll-free 8xx number (as illustrated in FIG. 16) based upon the simulation set up data assigned from the Master Controller. This access number is then used by the carrier's Softswitch/SCP 1606 to determine the appropriate platform to send the call to, in this case the Prepaid Calling platform 1612.

The carriers' Softswitch/SCP 1606 will relay the appropriate IP address for the Prepaid platform-controlling Gateway 1611 and signal the gateway of the incoming call via the TCP/IP stream 1622. The call will then be connected across the carrier's IP Transport network 1610 using the RTP/IP data transport protocol, to the carrier's centralized Packet Voice Gateway 1611 via the RTP/IP stream 1623 and from there to the carriers Prepaid Platform 1612 which then prompts the caller, in this embodiment the VCS Point of Presence Server #2 1609, for specific information regarding the prepaid calling card call being requested. This information usually, but not exclusively, consists of the account number and the desired termination number.

When this information is gathered and the account has been verified on the Prepaid Platform 1612 the prepaid platform will dial the terminating number assigned to VCS Point of Presence Server 1609. The carrier's Packet Voice Gateway 1607 will then send the dialing instructions onto the Softswitch 1606 which will translate the dialed number into an IP address that will determine which Packet Voice Gateway to send the packetized test pattern to once the connection has been established. This IP address information will be relayed via a TCP/IP stream 1622 over the Carrier's IP Transport network 1610. In this particular embodiment, the VCS Point of Presence Server #2 1609 will have dialed its' own termination number when prompted by the Prepaid Calling Platform 1612. The carriers' Softswitch/SCP 1606 will relay the appropriate IP address for the VCS Point of Presence Server #2 1609 and, assuming there is no obstruction on the access portion of the distributed network as outline above, the terminating VCS Point of Presence Server 1609 will receive a “ring signal” from the Voice Packet Gateway 1607. The VCS Point of Presence Server 1609 will “answer” the call and the connection will be made.

Once the call has been connected the VCS Point of Presence Server 1609 will select test patterns, from a plurality of test patterns that are optimized to simulate human voices. After VCS Point of Presence Servers 1609 has completed any necessary synchronization procedures needed for the selected test patterns that will be transferred, it will transfer the selected test patterns that will return to itself to identify a quality level of the Prepaid Calling Platform 1612 in isolation. The path taken will be similar to that described above, with the test patterns being generated by the VCS Point of Presence Server #2 1609, the call will pass through the Central Office 1608 via a Clarus Certified Access Loop 1620. The call will go through the carriers' Packet Voice Gateway 1607 through the Prepaid Calling Platform 1612, via RTP/IP stream 1623, and back up to the originating Packet Voice Gateway 1607 via RTP/IP stream 1626, from which it will be sent directly back to the originating VCS Point of Presence Server #2 1609 through the Central Office 1608 via a Clarus Certified Access Loop 1620 and to the VCS Point of Presence Server #2 1609 for termination.

When some or all selected test patterns have been transferred in the first direction from Point of Presence Server 1609 to Point of Presence Server 1609, it will cause the transfer of test patterns in the opposite direction to the first direction, from Point of Presence Server 1609 to Point of Presence Server 1609 to form full duplex operation.

This process continues until testing is complete and the VCS Point of Presence Servers 1609 will go back “on hook,” thereby disconnecting from the service under test.

The process described immediately above, can also be performed from VCS Point of Presence Server #3 1616. In this case the VCS Point of Presence Server #3 1616 would initiate a test or a series of tests using the same methods as those described for VCS Point of Presence Server #2 1609.

Another embodiment that isolates the Service Platform is one in which the Master Controller selects the VCS Point of Presence Server 1609 to initiate the transfer of a selected test pattern, or a series of test patterns, over a specific service platform (in this case Prepaid Calling service platform 1612) through the distributed Wholesale Carrier telecommunications network to one or a plurality of VCS Point of Presence Servers 1616, thereby isolating the Service Platform 1612 in between the two VCS Point of Presence Servers 1609 and 1616.

In this embodiment, the VCS Point of Presence Server 1609 that originates the connection to the service under test goes “off hook” and connects to the carriers Packet Voice Gateway 1607 through the Central Office 1608 via a Clarus Certified Access Loop 1620 and dials an Access Number, which is usually, but not exclusively a toll-free 8xx number based upon the simulation set up data assigned from the Master Controller. This access number is then used by the carrier's Softswitch/SCP 1606 to determine the appropriate platform to send the call to, in this case the Prepaid Calling Platform 1612.

The carriers' Softswitch/SCP 1606 will relay the appropriate IP address for the Prepaid platform-controlling Gateway 1611 and signal the gateway of the incoming call via the TCP/IP stream 1622. The call will then be connected across the carrier's IP Transport network 1610 using the RTP/IP data transport protocol, to the carriers' centralized Packet Voice Gateway 1611 via the RTP/IP stream 1623 and from there to the carrier's Prepaid Platform 1612 which then prompts the caller, in this embodiment the VCS Point of Presence Server 1609, for specific information regarding the prepaid calling card call being requested. This information usually, but not exclusively, consists of the account number and the desired termination number.

When this information is gathered and the account has been verified on the Prepaid Platform 1612 the Prepaid Platform will dial the terminating number assigned to VCS Point of Presence Server 1616. The carrier's Packet Voice Gateway 1607 will send the dialing instructions onto the Softswitch 1606 which will translate the dialed number into an IP address that will determine which Packet Voice Gateway to send the packetized test pattern to once the connection has been established. This IP address information will be relayed using one of a plurality of control protocols to communicate with the Softswitch 1613 controlling the far end Packet Voice Gateway 1614 via a TCP/IP stream 1624 over the Carrier's IP Transport network 1610.

The terminating Softswitch 1613 will then relay the appropriate termination IP address to the Terminating Packet Voice Gateway 1614. Unlike the first embodiment described in this figure (end-to-end), the call will not go to the Access Tandem 1617 but will go directly to the VCS Point of Presence Server #3 1616 through the Central office 1615 via a Clarus Certified Access Loop 1621. The Packet Voice Gateway 1614 will then send a “Ring Tone” to the terminating VCS Point of Presence Server #3 1616 for termination. Assuming there is no obstruction on the Prepaid Calling Service Platform of the distributed network as outline above, the terminating VCS Point of Presence Server 1616 will receive a “ring signal” from the Voice Packet Gateway 1614. The VCS Point of Presence Server 1616 will “answer” the call and the connection will be made.

Once the call has been connected the VCS Point of Presence Server 1609 will select test patterns, from a plurality of test patterns that are optimized to simulate human voices. After VCS Point of Presence Servers 1609 and 1616 complete any necessary synchronization procedures needed for the selected test patterns that will be transferred, Point of Presence Server 1609 will transfer the selected test patterns to Point of Presence Server 1616 to identify a quality level of the Prepaid Calling Platform 1612 in the distributed telecommunication network between the one Point of Presence Server 1609 and the other Point of Presence Server 1616. The path taken will be similar to that described above, with the test patterns being generated by the VCS Point of Presence Server 1609, the call will pass through the Central Office 1608 via a Clarus Certified Access Loop 1620, and is forwarded onto the carriers Packet Voice Gateway 1607 where the test pattern is converted from a standard analog signal into digitized packets to be sent across the carrier's IP Transport network 1610 using the RTP/IP data transport protocol. The digitized test pattern then flows over the RTP/IP stream 1623 to Packet Voice Gateway 1611. At Packet Voice Gateway 1611 the test pattern flows into, and out of, Prepaid Platform 1612 returning into Packet Voice Gateway 1611. The digitized test pattern then flows over the RTP/IP stream 1625 to Packet Voice Gateway 1614. When the packetized test pattern exits the Packet Voice Gateway 1614 it gets translated back into an analog signal from it's digitized form and finally is sent out to the terminating VCS Point of Presence Server #3 1616 through the Central Office 1615 via a Clarus Certified Access Loop 1621.

When some or all selected test patterns have been transferred in the first direction from Point of Presence Server 1609 to Point of Presence Server 1616, the two Point of Presence Servers will communicate and cause the transfer of test patterns in the opposite direction to the first direction, from Point of Presence Server 1616 to Point of Presence Server 1609 to form full duplex operation.

This process continues until testing is complete and the VCS Point of Presence Servers 1609 and 1616 will go back “on hook,” thereby disconnecting from the service under test.

The final embodiment described in FIG. 16 is to provide isolation testing of the termination services provider. In this embodiment the Master Controller will initiate a simulated test pattern, or a series of test patterns, in order to isolate a specific termination route or carrier through the distributed Wholesale Carrier network to one or a plurality of VCS Point of Presence Servers 1619.

In this final embodiment, the Master Controller will select the VCS Point of Presence Server #3 1616 to initiate the transfer of a selected test pattern, or a series of test patterns, over a specific termination route through the distributed Wholesale Carrier telecommunications network to one of a plurality of VCS Point of Presence Servers 1619, the VCS Point of Presence Server 1616 that originates the connection to the service under test goes “off hook” and connects to the carriers Packet Voice Gateway 1614 through the Central Office 1615 via a Clarus Certified Access Loop 1621 and dials an Access Number, which is usually, but not exclusively a toll-free 8xx number based upon the simulation set up data assigned from the Master Controller. The Softswitch/SCP 1613 will translate the access number dialed by the VCS Point of Presence Server #3 1616 to determine the appropriate Packet Voice Gateway 1614 for termination. The carriers' Softswitch/SCP 1613 will relay the appropriate termination number to the Packet Voice Gateway 1614 and will send the call to the local Access tandem 1617 via the Packet Voice Gateway 1614. Here the Access Tandem 1617 will determine to which Central Office 1618 the call should be sent for termination.

The Central Office 1618 will then determine where to send a ring signal based upon the last 7 digits of the termination number provided by the Softswitch/SCP 1613. Assuming there is no obstruction on the distributed network as outline above, the terminating VCS Point of Presence Server 1619 will receive a “ring signal” from the Central Office 1618. The VCS Point of Presence Server 1619 will “answer” the call and the connection will be made.

Once the call has been connected the VCS Point of Presence Server 1616 will select test patterns, from a plurality of test patterns that are optimized to simulate human voices, After VCS Point of Presence Servers 1616 and 1619 complete any necessary synchronization procedures needed for the selected test patterns that will be transferred, Point of Presence Server 1616 will transfer the selected test patterns to Point of Presence Server 1619 to identify a quality level of the termination portion of the distributed telecommunication network between the one Point of Presence Server 1616 and the other Point of Presence Server 1619. The path taken will be similar to that described above, with the test patterns being generated by the VCS Point of Presence Server 1616, the call will pass through the Central Office 1615 via a Clarus Systems Certified Access Loop 1621 directly to the Carriers Packet Voice Gateway 1614 where the call is first digitized and then translated back into an analog signal from it's digitized form. The call is then sent through the Access Tandem 1617 through the Central Office 1618 and finally to the VCS Point of Presence Server 1619.

When all selected test patterns have been transferred in the first direction from Point of Presence Server 1616 to Point of Presence Server 1619, the two Point of Presence Servers will communicate and cause the transfer of test patterns in the opposite direction to the first direction, from Point of Presence Server 1619 to Point of Presence Server 1616 to form full duplex operation.

This process continues until testing is complete and the VCS Point of Presence Servers 1616 and 1619 will go back “on hook,” thereby disconnecting from the service under test.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

FIG. 17 is a simplified diagram of an overall system according to an alternative embodiment of the present invention. This diagram is merely an example, which should not unduly limit the scope of the claims herein. One of ordinary skill in the art would recognize many other variations, modifications, and alternatives.

The system shown in FIG. 17 includes the subsystems that typically comprise an alternative embodiment of a Point of Presence Server, all interconnected for data communications, via an Ethernet LAN 173. The IP-WAN 170 is used to supply data connections between a Point of Presence (POP) Server and the Master Controller for purposes including, but not limited to: the scheduling of test pattern transfers for monitoring, the scheduling of test pattern transfers for user requested demand testing, the management of the operation and data communication between itself and a plurality of Point of Presence Server systems, the management of overall system operations and reliability for the software and hardware in the Master Controller systems and in the plurality of Point of Presence Server systems, and the transport of measurement results from the Point of Presence Server system to the Master Controller.

All data sent to, or received from, the IP-WAN 170 is via a Router/Firewall 171. The firewall function of the Router/Firewall maintains security for data access to the Point of Presence Server, insuring that only authorized transactions are enabled. Router functions of the Firewall/Router connects the Ethernet LAN to the IP-WAN.

A plurality of Test Control Computers With Embedded Test Systems 172 provide computing resources for the software that performs selected or all control, formatting, and management functions at the Point of Presence Server system including: receipt, formatting, and management of instructions from the Master Controller, transmission and formatting of test pattern measurement result data to the Master Controller, and related operational and maintenance functions.

Each of the Test Control Computers With Embedded Test Systems contain one of a plurality of multi-port test systems 179, of various type suited to the plurality of services under test and network technologies supporting those services. Upon receipt of instructions from the Master Controller the Test Control Computers With Embedded Test Systems 172 will select which of its contained multi-port test system 179 is best suited to support the transmission of the requested test pattern via the active state network of a particular technology. The Test Control Computer then will format a set of test control commands and transmit them to the selected multi-port test system via the computer's internal bus. When the multi-port test system has completed the transmission of the selected test patterns to one of the Test Control Computers With Embedded Test Systems 172 at a geographically separate point of presence location, it will report the measurement results to the Test Control Computer software. The Test Control Computers With Embedded Test Systems 172 will then format and transmit those results to the Master Controller via the Ethernet LAN 173 and the IP-WAN 170.

Test Access Circuits 174 connect the Test Control Computers With Embedded Test Systems 172 to the Multiplex System 175 that is, in turn, connected via Service Access 176 to the Access Network 177 and via the Access network to the plurality of services supported by the Distributed Telecommunication Networks 178. Test Access circuits 174 are composed of a range of technologies appropriate to the plurality of services and network technologies being tested and provide connections that remain within the physical location of one of the Point of Presence Servers and provide intra-location connections for the transmission of test patterns. The Multiplex System also is linked to the Test Control Computers With Embedded Test Systems 172 via the Ethernet LAN 173. The Multiplex System 175 performs a “grooming” function by allowing, at the command of the Test Control Computer Systems, the connection of one of a plurality of Test Systems to one of a plurality of Distributed Telecommunication Networks as needed while avoiding having service access capacity idle. Service Access circuits 176 are composed of a range of technologies appropriate to the plurality of services and network technologies being tested and provide connections from the Point of Presence Servers to the public local access network for the purpose of providing transport connections for the transmission of test patterns. Service Access circuits are of many types and technologies and are designed to accurately emulate the actual access methods used by actual customers of the service under test to gain access to that service. In summary, the interconnection of Test Control Computers With Embedded Test Systems 172 to Distributed Telecommunication Networks 178 is accomplished via the controlled and coordinated application of subsystems 174, 175, 176, and 177.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

FIG. 18 is a simplified diagram of an overall system according to an alternative embodiment of the present invention. This diagram is merely an example, which should not unduly limit the scope of the claims herein. One of ordinary skill in the art would recognize many other variations, modifications, and alternatives.

The system shown in FIG. 18 includes the subsystems that typically comprise an alternative embodiment of a Point of Presence Server, selected or all interconnected for data communications, via an Ethernet LAN 183. The IP-WAN 180 is used to supply data connections between a Point of Presence (POP) Server and the Master Controller for purposes including, but not limited to: the scheduling of test pattern transfers for monitoring, the scheduling of test pattern transfers for user requested demand testing, the management of the operation and data communication between itself and a plurality of Point of Presence Server systems, the management of overall system operations and reliability for selected or all the software and hardware in the Master Controller systems and in the plurality of Point of Presence Server systems, and the transport of measurement results from the Point of Presence Server system to the Master Controller.

All data sent to, or received from, the IP-WAN 180 is via a Router/Firewall 181. The firewall function of the Router/Firewall maintains security for data access to the Point of Presence Server, insuring that only authorized transactions are enabled. Router functions of the Firewall/Router connects the Ethernet LAN to the IP-WAN.

A plurality of Test Control Computers With Embedded Audio Recognition Systems 182 provide computing resources for the software that performs selected or all control, formatting, and management functions at the Point of Presence Server system including: receipt, formatting, and management of instructions from the Master Controller, transmission and formatting of test pattern measurement result data to the Master Controller, and related operational and maintenance functions.

Each of the Test Control Computers With Embedded Audio Recognition Systems contain one of a plurality of multi-port audio recognition systems 189, of various type suited to the plurality of services under test and network technologies supporting those services. Upon receipt of instructions from the Master Controller the Test Control Computer With Embedded Audio Recognition Systems 182 will select which of its contained multi-port audio recognition systems is best suited to support the determination of the quality level of the pre-recorded audio message 189 as received via the active telecommunication network between the telecommunication answering device and the Point of Presence Server. The Test Control Computer then will format a set of test control commands and transmit them to the selected multi-port audio recognition system via the computer's internal bus. When the multi-port audio recognition system has completed reception and analysis of the selected pre-recorded audio message 189, it will report the measurement results to the Test Control Computer software. The Test Control Computer With Embedded Audio Recognition Systems 182 will then format and transmit those results to the Master Controller via the Ethernet LAN 183 and the IP-WAN 180.

Test Access Circuits 184 connect the Test Control Computers With Embedded Audio Recognition Systems 182 to the Multiplex System 185 that is, in turn, connected via Service Access 186 to the Access Network 187 and via the Access network to the plurality of services supported by the Distributed Telecommunication Networks 188. Test Access circuits 184 are composed of a range of technologies appropriate to the plurality of services and network technologies being tested and provide connections that remain within the physical location of one of the Point of Presence Servers and provide intra-location connections for the transmission of test patterns. The Multiplex System also is linked to the Test Control Computers With Embedded Audio Recognition Systems 182 via the Ethernet LAN 183. The Multiplex System 185 performs a “grooming” function by allowing, at the command of the Test Control Computer Systems, the connection of one of a plurality of Test Systems to one of a plurality of Distributed Telecommunication Networks as needed while avoiding having service access capacity idle. Service Access circuits 186 are composed of a range of technologies appropriate to the plurality of services and network technologies being tested and provide connections from the Point of Presence Servers to the public local access network for the purpose of providing transport connections for the transmission of test patterns. Service Access circuits are of many types and technologies and are designed to accurately emulate the actual access methods used by customers of the service under test to gain access to that service. In summary, the interconnection of Test Control Computers With Embedded Audio Recognition Systems 182 to Distributed Telecommunication Networks 188 is accomplished via the controlled and coordinated application of subsystems 184, 185, 186, and 187.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

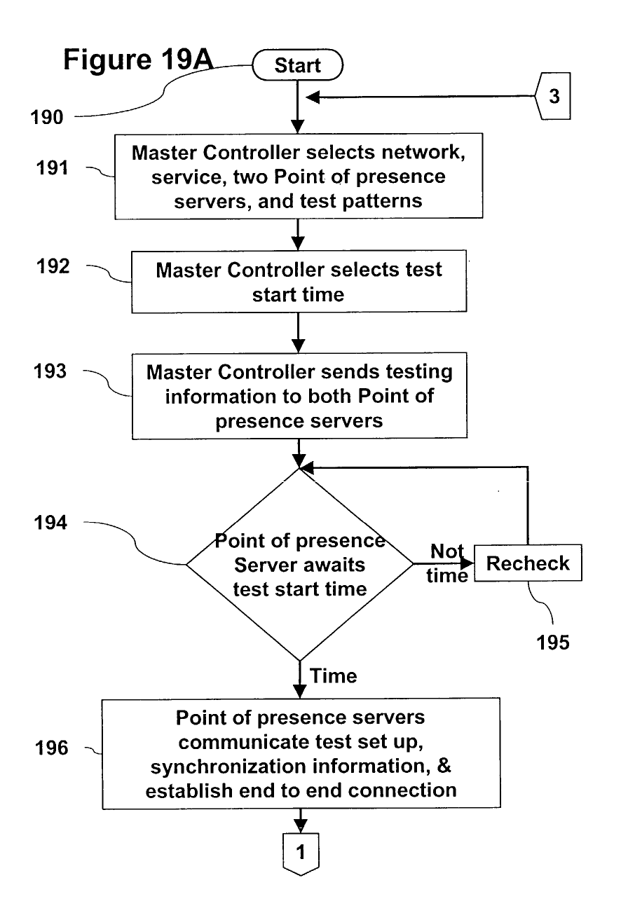

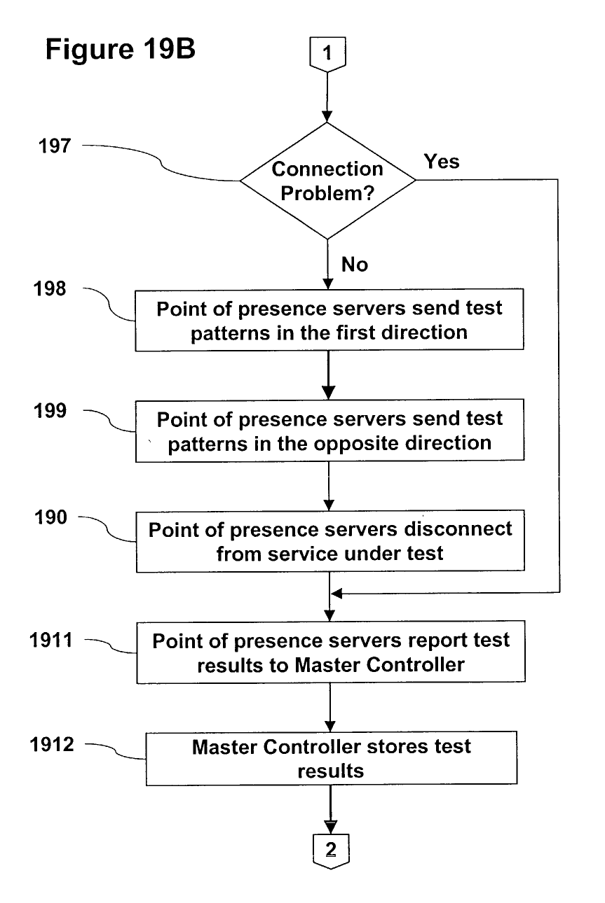

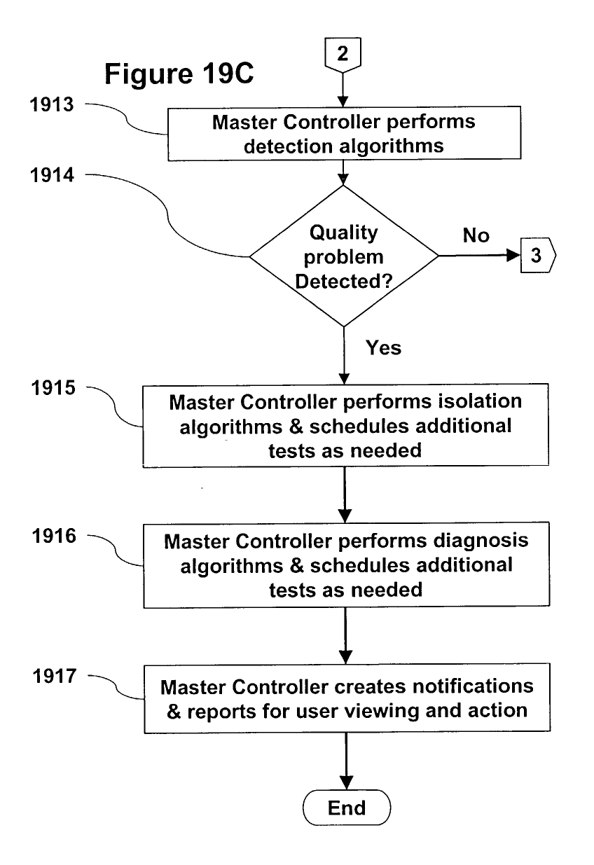

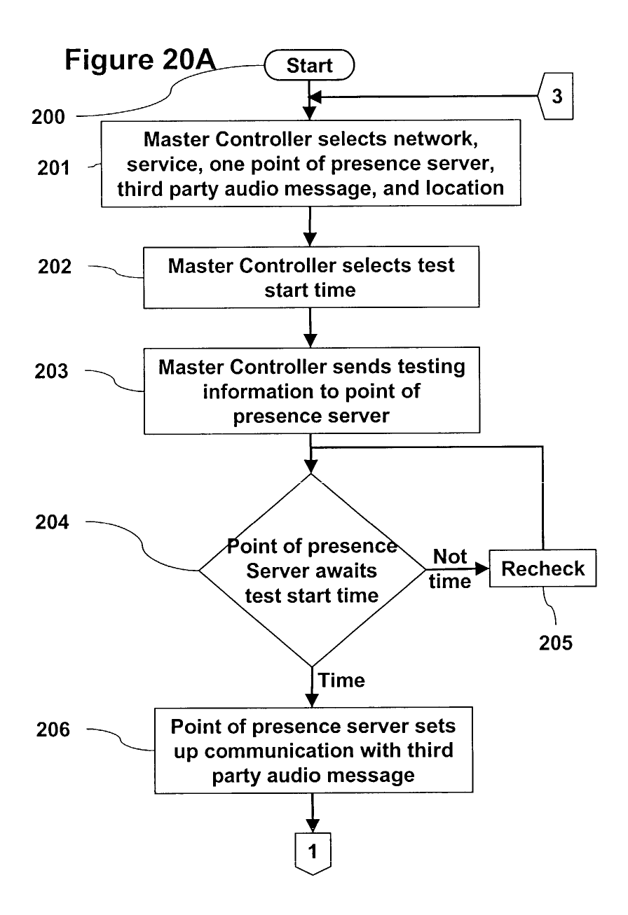

FIG. 19 is a flow chart illustrating a method of measuring and analyzing end-to-end service quality in an active network according to an embodiment of the present invention. This diagram is merely an example, which should not unduly limit the scope of the claims herein. One of ordinary skill in the art would recognize many other variations, modifications, and alternatives.

FIG. 19 illustrates the preferred method for monitoring and analyzing quality of service from end-to-end using a simulation during an active state of a telecommunication network.

Block 191 shows the first step in initiating an end-to-end simulation. The Master Controller initiates an end-to-end simulation either by following scheduling rules for monitoring, or in response to a request for immediate demand testing from a user's Internet Browser Client. The Master Controller computer software uses its stored rules to select the parameters of simulations needed for each customer's monitored services. The Master Controller selects a customer, the customer's network, the particular service, two Point of Presence Servers, and the particular test pattern or patterns that will be transferred in the active network. The Point of Presence Servers are selected from a plurality of Point of Presence Servers and are those with the appropriate geographic location and test pattern generation capability to test the network and service at hand. In addition, the Master Controller will also designate one, of the two, Point of Presence Servers to be the originating Point of Presence Server and the other Point of Presence Server to be the terminating Point of Presence Server. Originating and terminating are defined in the context of the selected network and service. It should be understood that each Point of Presence Server is designed to act as the originator of test sequences or the terminator of test sequences simultaneously over a plurality of service access methods and connections.

Also in Block 191 test patterns are selected from a plurality of test patterns appropriate to the particular service that will be tested. The particular test patterns that are selected from the plurality of test patterns will be associated with one of at least two categories of test patterns, the first category being optimized for rapid detection of quality degradations above a pre-selected threshold value, the second and subsequent patterns being optimized for diagnosis of the degradation detected by the test pattern of the first category, each subsequent pattern being optimized for diagnosis in greater depth than preceding test patterns. Selected or all these parameters and test patterns taken together, also called the simulation set up data, are stored in the Master Controller's database.

In Block 192 the Master Controller selects a starting time for one of the many simulations that it set up as shown in Block 191. This starting time is selected by one of several algorithms, some of which optimize the ability of the system to rapidly detect degradations in end-to-end quality, and others that optimize various sampling strategies necessary for drawing correct inferences from the end-to-end quality data gathered.

In Block 193 the Master Controller sends the simulation set up data, the starting time data, and other administrative data elements to both of the Point of presence servers that will be involved in performing the simulation, gathering the quality data, and reporting the results. This data is sent on a per simulation basis using secure and robust queuing software.

Decision Block 194 indicates the Point of Presence Server that the Master Controller selected to be the originating server, awaiting the start time for the next simulation. If it is not yet time, the Point of Presence Server software will sleep for a short time, then check again, as shown in Block 195 to determine if it is now time to perform the scheduled simulation. This process of sleeping, rechecking, and sleeping again will continue until the Point of Presence Server software determines that it is time to perform the scheduled simulation. When this occurs the software will stop rechecking and move onto Block 196.

As indicated by Block 196, when the test start time has been reached, the originating (as designated by the Master Controller in Block 191) Point of Presence Server will initiate any necessary synchronization procedures needed for the selected test pattern or patterns. The terminating Point of Presence Server replies to the receipt of test parameters with any necessary status information and indicates its readiness to receive the selected test pattern or patterns. The terminating Point of Presence Server will then perform, in coordination with the originating Point of Presence Server, its part of the synchronization procedures.

In addition, Block 196 indicates the originating Point of Presence Server establishing end-to-end connection, via the customer's active network and service as selected by the Master Controller Block 191, with the selected terminating Point of Presence Server. The originating Point of Presence Server will use one of plurality of processes for connecting to services under test, selecting the process appropriate for the particular service under test. During this process the originating Point of Presence Server records the time intervals between each step in the process for each of a number of steps, varying between one step and several steps, and adds those time intervals to the measurements to be reported to the Master Controller as depicted in Block 1911.

If the originating Point of Presence Server is unable to establish a connection to the terminating Point of Presence Server, via the customer's active network and service, as indicated by decision Block 197, the Point of Presence Server will stop attempting to connect to the selected service and network. The Point of Presence Server will then proceed to Block 1911 and report the connection failure to the Master Controller, along with any time intervals that were recorded for those steps in the connection process that were completed.

Block 198 indicates the originating Point of Presence Server sending the selected test patterns to the terminating Point of Presence Server. These test patterns are transmitted in the first direction of two directions. The test pattern or patterns were first selected by the Master Controller in Block 191 and are sent in the first direction by the originating Point of Presence Server in the sequence that was also selected by the Master Controller Block 191.

Block 199 indicates the terminating Point of Presence Server sending the selected test patterns to the originating Point of Presence Server. These test patterns are transmitted in the opposite direction to the first direction to form fall duplex operation. The test pattern or patterns were first selected by the Master Controller in Block 191 and are sent in the opposite direction by the terminating Point of Presence Server in the sequence that was also selected by the Master Controller.

As shown in Block 1910, when the Point of Presence Servers on both ends of the customer's active network and service that is being tested have completed sending and receiving the selected test patterns in both the first direction and in the opposite direction to the first direction, the two Point of Presence Servers will agree that they have completed selected or all necessary testing by the communication of status data. If the status data are correct the originating Point of Presence Server will perform the steps necessary to disconnect from the customer's active network and service that was tested.

In Block 1911 both Point of Presence Servers will then reformat the measurement results, time interval results, and other data previously collected (Blocks 198 and 199) into a standard format. Next, both Point of Presence Servers will transmit the measurement results to the Master Controller. This data is sent as soon as each simulation has completed using secure and robust queuing software.

As indicated in Block 1912 the Master Controller will then store the measurement results, time interval results, and other data in its On Line Transaction Processing (OLTP) database. This database is optimized for the rapid insertion and immediate analysis of the collected measurement results.

As may be seen in Block 1913, once the Master Controller has collected and stored the collected results in the OLTP database, the Master Controller software will apply one or more of several different detection algorithms to the just arrived measurement data. The detection algorithms are optimized to detect when the received test patterns have indicated that there is a quality problem severe enough to warrant further isolation and diagnosis. These algorithms are selected to be most appropriate to the characteristics of service being tested and those of the active Distributed Telecommunication Network and may include, but are not necessarily limited to: comparison to industry standard quality thresholds, customer defined quality thresholds, and statistical comparisons with recent quality data collected from the current customer's same service and same active network.

Decision Block 1914 indicates a decision made after the application of the Master Controller's detection algorithms in Block 1913. If the detection algorithms have not indicated that there is an end-to-end service quality problem with severity exceeding any of the various thresholds, the software will return to the starting point, Block 190. If there has been a quality problem detected with severity exceeding any of the various thresholds, the Master Controller software will proceed to the processing as indicated by Block 1915 to order further testing and analysis.

Block 1915 shows the processing in which the Master Controller software accomplishes the isolation of the geographic location of the network element, or elements, that are causing the observed degradation in end-to-end service quality. The Master Controller software applies these algorithms in two groupings: first the software performs isolation algorithms using the data just collected in comparisons with recent data collected from the same service and from the same active network and from a plurality of Point of Presence Servers in addition to first Point of Presence Server as selected in Block 191. If the isolation algorithms have been able to isolate, for the current customer, the geographic location of the causing network element with sufficient certainty, the Master Controller will proceed to the processing indicated in Block 1916. If not, the Master Controller software will execute one or more of the second set of algorithms that will result in the scheduling of one or more additional test patterns to be sent, by selected Point of Presence Servers, across a selected subset of the plurality of routes of the active network. When a sufficient level of certainty regarding the geographic location of the causing network element, the Master Controller software will stop scheduling the transmission of additional test patterns and proceed to the processing indicated in Block 1916.

In Block 1916, having already isolated the geographic location of the network element, or elements, that are causing the observed degradation in end-to-end service quality, the Master Controller software will apply algorithms that will result in a diagnosis that indicates the type of network element that is the cause of the detected degradation. Some representative examples of network element type are router, packet voice gateway, fiber optic transmission, cable transmission, mobile radio transmission, soft switch, and matrix switch. The Master Controller software applies these algorithms in two groupings: first the software performs diagnosis algorithms using the data just collected in comparisons with historical data collected from the same and similar services in the current customer's active network. If the diagnosis algorithms have been able to isolate the type of the causing network element with sufficient certainty, the Master Controller will proceed to the processing indicated in Block 1917. If not, the Master Controller software will execute one or more of the second set of algorithms that will result in the scheduling of one or more additional test patterns to be sent, by selected Point of Presence Servers, across a selected subset of the plurality of routes of the active network. When a sufficient level of certainty regarding the type of the causing network element, the Master Controller software will stop scheduling the transmission of additional test patterns and proceed to the processing indicated in Block 1917.

As described in Block 1917, when the proceeding processing steps of detecting, isolating, and diagnosing, as required, degradations in the end-to-end service quality (Blocks 1913 through 1916) have been completed for the current test start time the Master Controller software completes the analysis of the recent measurement data and the preparation of information from that data. The Master Controller will add the most recent measurement results, time interval results and other data to the results available for review in the various user interfaces and reports. End users of the system gain access to the information via Internet Browser Thin Clients supported by the system host servers, as shown in FIGS. 1 and 2. In addition, according to customer defined notification rules, one or more of a range of notification algorithms will be executed to send notification to automated devices as defined in those rules. This notification sends to the particular customer designates, in summary, the information resulting from the steps of detecting, isolating, and diagnosing.

The above figures describe aspects of the invention illustrated by elements in simplified method diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art. Further details of the present system and methods provided by the system are described throughout the present specification and more particularly below.

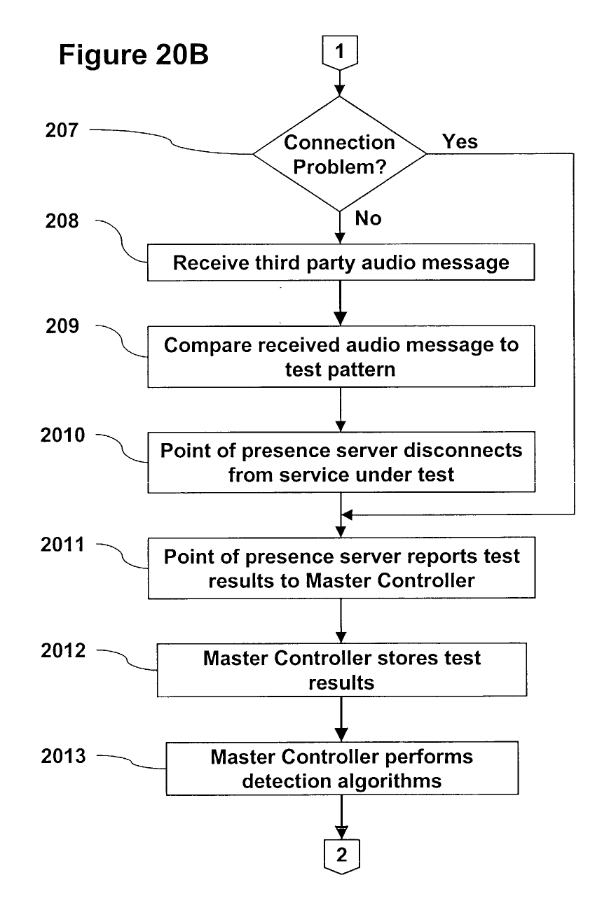

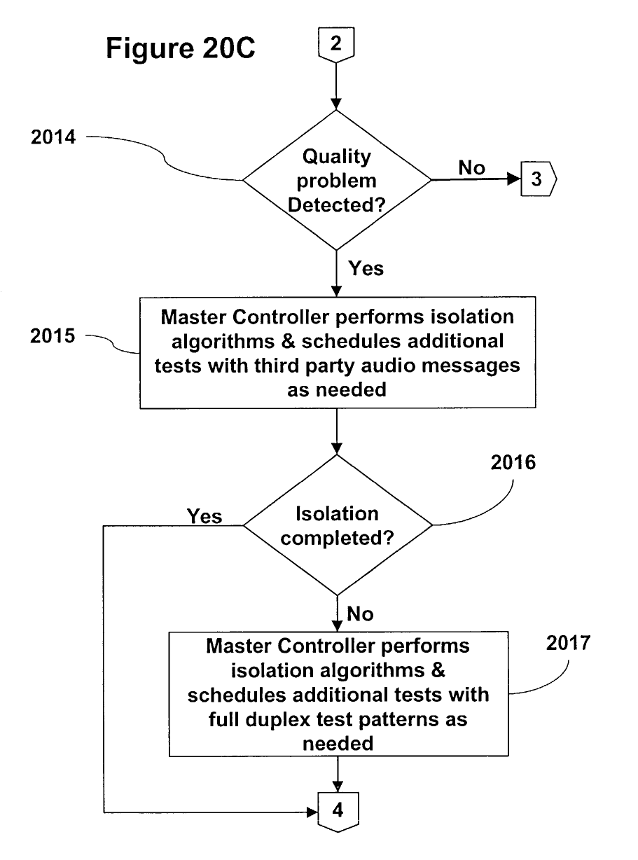

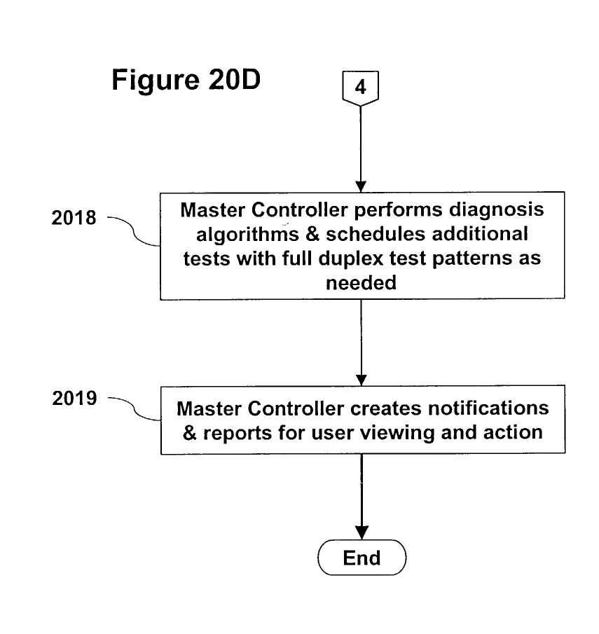

FIG. 20 is a flow chart illustrating an alternative method of measuring and analyzing end-to-end service quality in an active network. This diagram is merely an example, which should not unduly limit the scope of the claims herein. One of ordinary skill in the art would recognize many other variations, modifications, and alternatives.

FIG. 20 illustrates the preferred method for monitoring and analyzing quality of service from end-to-end using a method comprising receiving a pre-recorded third party audio message from one of a plurality of third party audio messages during an active state of a telecommunication network. The third party audio message is used to simulate the audio energy that would be applied by end users of the service under test.

Block 201 shows the first step in initiating an end-to-end measurement of service quality using a pre-recorded third party audio message. The Master Controller will initiate an end-to-end simulation either by following scheduling rules for monitoring, or in response to a request for immediate demand testing from a user's Internet Browser Client. The Master Controller computer software will use its stored rules to select the parameters of each measurement needed for each customer's monitored services. The Master Controller will select a customer, the customer's network, the particular service, a Point of Presence Server, a pre-recorded audio message, a service address for a telecommunications answering device that will play back the audio message, and the particular test pattern that simulates the audio message. The Point of Presence Server is selected from a plurality of Point of Presence Servers and is one with the appropriate geographic location to test the customer's active network and service. Selected or all these parameters and test patterns taken together, also called the simulation set up data, are stored in the Master Controller's database.

In Block 202 the Master Controller selects a starting time for one of the many end-to-end measurements that it set up as shown in Block 201. This starting time is selected by one of several algorithms, some of which optimize the ability of the system to rapidly detect degradations in end-to-end quality, and others that optimize various sampling strategies necessary for drawing correct inferences from the end-to-end quality data gathered.

In Block 203 the Master Controller sends the simulation set up data, the starting time data, and other administrative data elements to the Point of presence server that will be involved in performing the simulation, gathering the quality data, and reporting the results. This data is sent on a per simulation basis using secure and robust queuing software.

Decision Block 204 indicates the Point of Presence Server awaiting the start time for the next simulation. If it is not yet time, the Point of Presence Server software will sleep for a short time, then check again, as shown in Block 205 to determine if it is now time to perform the scheduled simulation. This process of sleeping, rechecking, and sleeping again will continue until the Point of Presence Server software determines that it is time to perform the scheduled simulation. When this occurs the software will stop rechecking and move onto Block 206.

As indicated by Block 206, the Point of Presence Server establishes end-to-end connection, via the customer's active network and service as selected by the Master Controller Block 201, with the selected third party telecommunications answering device that will, in turn, play back selected pre-recorded audio message. The Point of Presence Server will use one of plurality of processes for connecting to services under test, selecting the process appropriate for the particular service under test. During this process the Point of Presence Server records the time intervals between each step in the process for each of a number of steps, varying between one step and several steps, and adds those time intervals to the measurements to be reported to the Master Controller as depicted in Block 2011.

If the originating Point of Presence Server is unable to establish a connection with the selected third party telecommunications answering device, via the customer's active network and service, as indicated by decision Block 207, the Point of Presence Server will stop attempting to connect to the selected service and network. The Point of Presence Server will then proceed to Block 2011 and report the connection failure to the Master Controller, along with any time intervals that were recorded for those steps in the connection process that were completed.

Block 208 indicates the Point of Presence Server receiving the pre-recorded audio message from the third party telecommunications answering device as connected in Block 207. To gain access to the selected pre-recorded message the software in the Point of Presence Server will have to use one of a plurality of processes for interacting with the telecommunications answering devices, selected as appropriate for the logic of the particular answering device being used. The selected pre-recorded message is then replayed by the telecommunications answering device and received by the Point of Presence Server.

As indicated by Block 209 Point of Presence Server then will compare the pre-recorded message as received with the test pattern selected by the Master Controller (Block 201) and transmitted to the Point of Presence Server in the simulation set up data. The software of the Point of Presence Server will establish a “closeness of fit” that reports a measure of how closely the received version of the pre-recorded message compares with the test pattern selected to simulate that pre-recorded message.

As shown in Block 2010, when the Point of Presence Server has completed receiving pre-recorded message and comparing that message to the test pattern, the Point of Presence Server will perform the steps necessary disconnect from the customer's active network and service under test and, thereby, the telecommunications answering device.

In Block 2011 the Point of Presence Server will then reformat the measurement results, time interval results, and other data previously collected (Blocks 208 and 209) into a standard format. Next, the Point of Presence Server will transmit the measurement results to the Master Controller. This data is sent as soon as each simulation has completed using secure and robust queuing software.

As indicated in Block 2012 the Master Controller will then store the measurement results, time interval results, and other data in its On Line Transaction Processing (OLTP) database. This database is optimized for the rapid insertion and immediate analysis of the collected measurement results.

As may be seen in Block 2013, once the Master Controller has collected and stored the collected measurement results in the OLTP database, the Master Controller software will apply one or more of several different detection algorithms to the just arrived measurement data. The detection algorithms are optimized to detect when the comparison of the received pre-recorded audio message with the test pattern, reported as a closeness of fit measure, indicates that there is a quality problem severe enough to warrant further isolation and diagnosis. These algorithms are selected to be most appropriate to the characteristics of service being tested and those of the active Distributed Telecommunication Network and may include, but are not necessarily limited to: comparison to industry standard quality thresholds, customer defined quality thresholds, and statistical comparisons with recent quality data collected from the current customer's same service and same active network.

Decision Block 2014 indicates a decision made after the application of the Master Controller's detection algorithms in Block 2013. If the detection algorithms have not indicated that there is an end-to-end service quality problem with severity exceeding any of the various thresholds (, the software will return to the starting point, Block 200. If there has been a quality problem detected with severity exceeding any of the various thresholds, the Master Controller software will proceed to the processing as indicated by Block 2015 to order further testing and analysis.

Block 2015 shows the processing in which the Master Controller software accomplishes the isolation of the geographic location of the network element, or elements, that are causing the observed degradation in end-to-end service quality. The Master Controller software applies these algorithms in two groupings: first the software performs isolation algorithms using the data just collected in comparison with recent data collected from the same service and from the same active network and from analyses of a plurality of pre-recorded audio messages in addition to first pre-recorded audio message as selected in Block 201, combining historical information collected by this method using third party audio messages and historical information collected by the method of transmitting and measuring, full duplex, test patterns in the same active network and from a plurality of Point of Presence Servers. Both types of information are collected from the same customer's service and from the same active network. If the isolation algorithms have been able to isolate the geographic location of the causing network element with sufficient certainty, the Master Controller will proceed to the decision indicated in Block 2016. If not, the Master Controller software will execute one or more of the second set of algorithms that will result in the scheduling of one or more end-to-end connections to be established with third party telecommunications answering devices, by selected Point of Presence Servers, across a selected subset of the plurality of routes of the active network. Each of the connections will result in the collection of an additional quality measurement of the service under test. After completing the second set of algorithms the Master Controller software will proceed to the decision indicated in Block 2016.

In the decision block labeled as Block 2016 the Master Controller software will determine if the additional analysis and/or measurements collected by executing the algorithms of Block 2015 have isolated the geographic location of the causing network element with sufficient certainty. If so, processing will move to Block 2018 to complete diagnosis aimed at determining the type of network element that is causing the degradation in service quality. If not, the software will move on to perform additional testing for isolation as indicated in Block 2017.

As indicated by Block 2017 the Master Controller software will execute one or more of the second set of algorithms that will result in the scheduling the transmission and analysis of one or more additional full duplex test patterns to be sent, by selected Point of Presence Servers to other selected Point of Presence Servers, across a selected subset of the plurality of routes of the active network. When a sufficient level of certainty regarding the geographic location of the causing network element, the Master Controller software will stop scheduling the transmission of additional test patterns and proceed to the processing indicated in Block 2018.

In Block 2018, having already isolated the geographic location of the network element, or elements, that are causing the observed degradation in end-to-end service quality, the Master Controller software will apply algorithms that will result in a diagnosis that indicates the type of network element that is the cause of the detected degradation. Some representative examples of network element type are router, packet voice gateway, fiber optic transmission, cable transmission, mobile radio transmission, soft switch, and matrix switch. The Master Controller software applies these algorithms in two groupings: first the software performs diagnosis algorithms using the data just collected in comparisons with historical data collected from the same and similar services in the current customers' active network. If the diagnosis algorithms have been able to isolate the type of the causing network element with sufficient certainty, the Master Controller will proceed to the processing indicated in Block 2019. If not, the Master Controller software will execute one or more of the second set of algorithms that will result in the scheduling of one or more additional test patterns to be sent, by selected Point of Presence Servers, across a selected subset of the plurality of routes of the current customer's active network and service. When a sufficient level of certainty regarding the type of the causing network element, the Master Controller software will stop scheduling the transmission of additional test patterns and proceed to the processing indicated in Block 2019.

As described in Block 2019, when the proceeding processing steps of detecting, isolating, and diagnosing, as required, degradations in the end-to-end service quality (Blocks 2013 through 2018) have been completed for the current test start time the Master Controller software completes the analysis of the recent measurement data and the preparation of information from that data. The Master Controller will add the most recent measurement results, time interval results, and other data to the results available for review in the various user interfaces and reports. End users of the system gain access to the information via Internet Browser Thin Clients supported by the system host servers, as shown in FIGS. 1 and 2. In addition, according to customer defined notification rules, one or more of a range of notification algorithms will be executed to send notification to automated devices as defined in those rules. This notification sends to the particular customer designates, in summary, the information resulting from the steps of detecting, isolating, and diagnosing.

The above figures describe aspects of the invention illustrated by elements in simplified method and system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware. Alternatively, some of the elements may be combined together or even separated. Additionally, discrete digital and/or analog components can also be used. These and other variations, modifications, and alternatives will be apparent by one of ordinary skill in the art.

The above embodiments are merely provided to show examples of ways of implementing the present invention. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system for monitoring telecommunications services end-to-end through a distributed network environment, the system comprising:
a distributed telecommunication network, the distributed telecommunication network being capable of providing communications to a plurality of users during an active state;
a plurality of point of presence servers distributed throughout the geographic regions served by the distributed telecommunications network, each of the point of presence servers being adapted to provide at least a test pattern from a plurality of test patterns where each of the test patterns corresponds respectively to at least one of a plurality of services, whereupon the test pattern is transferred from one of the point of presence servers to another point of presence server to identify a quality level of the distributed telecommunication network between the one point of presence server and the other point of presence server; and
a master controller coupled to each of the point of presence servers via an Internet Protocol Wide Area Network (IP-WAN), the master controller being adapted to select at least one of the services for which a use of the selected service by a user of the selected service is simulated by one of the point of presence servers where the one point of presence server transfers the test pattern associated with the selected service to the other point of presence server, the master controller being adapted to receive information associated with the quality level of the distributed telecommunication network from one of the point of presence servers.

2. The system of claim 1 wherein the services include voice, data, messaging, video, voice conferencing, video conferencing, auto-attendant PBX services, Interactive Voice Response Systems based information recovery and order entry services, mobile data delivery services, mobile web access services, internet web access services, and internet media delivery services.

3. The system of claim 1 wherein the distributed telecommunication network includes one or more networks selected from a group consisting of an IP network, a mobile network, a video network, a cable network, a TDM network, an analog network, ATM network, Frame Relay network, satellite network, Ethernet network, fixed wireless network, fiber networks, and microwave distribution and communication networks.

4. The system of claim 1 wherein the point of presence servers are geographically distributed throughout a plurality of cities served by the distributed telecommunication network.

5. The system of claim 1 wherein the test pattern is transferred during the active state of the distributed telecommunication network.

6. The system of claim 1 wherein the other point of presence server that receives the test pattern is adapted to process the test pattern to identify the quality level.

7. The system of claim 6 wherein the process is adapted to compare the received test pattern with a stored test pattern.

8. The system of claim 1 wherein the test pattern that is transferred from one of the point of presence servers to another point of presence server identifies the quality level of the distributed telecommunication network between the one point of presence server and the other point of presence server in a first direction.

9. The system of claim 1 wherein a second test pattern is transferred from the other point of presence server to the one point of presence server to identify a second quality level of the distributed telecommunication network between the one point of presence server and the other point of presence server in a second direction, where the second direction is opposite to the first direction to form full duplex operation.

10. The system of claim 1 wherein the master controller is adapted to receive, store, and prepare information associated with the test pattern for a plurality of simulations, where each of the simulations is associated with one of the plurality of services.

11. The system of claim 1 wherein the plurality of test patterns are stored in a library.

12. The system of claim 1 wherein one or more of the test patterns is at least simulated or retrieved from memory.

13. The system of claim 1 wherein the test pattern is transferred without any substantial interference to any of a plurality of users during the active state.

14. The system of claim 13 wherein test pattern is transparent to any of the plurality of users during the active state.

15. The system of claim 1 wherein the master controller is adapted for monitoring of one or more distributed telecommunications networks for more than one customer.

16. The system of claim 15 wherein the plurality of point of presence servers are coupled to one or more distributed telecommunications networks for more than one customer.

17. The system of claim 1 wherein the master controller comprises a detection module, the detection module being adapted to monitor the test pattern through one or more anomalies in the distributed telecommunication network.

18. The system of claim 17 wherein the master controller further comprises an isolation module, the isolation module being adapted to identify a location of one of the anomalies.

19. The system of claim 18 wherein the location is associated with a geographical location.

20. The system of claim 19 wherein the master controller further comprises a diagnostic module, the diagnostic module being adapted to identify a type of network element, a sub-network, and a type of transport technology in the telecommunication network associated with one of the anomalies in the geographical location.

21. The system of claim 19 wherein one of the anomalies is associated with a type of network element in the telecommunication network at the geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

22. The system of claim 20 wherein one of the anomalies is associated with a sub-network portion of the telecommunication network at the geographic location, the sub-network being selected from a access signaling network, access transport network, core signaling network, core transport network, terminating signaling network, and terminating transport network.

23. The system of claim 22 wherein one of the anomalies is associated with each of the sub-networks is further associated with one or more network transport technologies in the sub-network portion of the telecommunications network, the network transport technologies being selected from a group consisting of an IP network, a mobile network, a video network, a cable network, a TDM network, an analog network, ATM network, Frame Relay network, satellite network, Ethernet network, fixed wireless network, fiber networks, and microwave distribution and communication networks.

24. A system for monitoring telecommunications services end-to-end through a distributed network environment, the system comprising:
a plurality of point of presence servers distributed throughout cities served by a distributed telecommunication network, each of the point of presence servers being adapted to provide a test pattern from a plurality of test patterns where each of the test patterns corresponding respectively to one of a plurality of services, whereupon the test pattern is transferred from a first point of presence server to a second point of presence server to identify a quality level of the distributed telecommunication network between the first point of presence server and the second point of presence server; and
a master controller coupled to each of the point of presence servers via a selected Protocol Wide Area Network (IP-WAN), the master controller being adapted to select one of the services to be simulated by the first point of presence server whereupon the first point of presence server transferred the test pattern associated with the selected service to the second point of presence server, the master controller being adapted to monitor information associated with the quality level of the distributed telecommunication network from one of the point of presence servers.

25. A method for monitoring telecommunication services end-to-end through a distributed network, the method comprising:
identifying a pre-recorded third party audio message from one of a plurality of third party audio messages, each of the third party audio messages being stored in memory associated with the third party of a telecommunication answering device;
connecting from one of a plurality of point of presence servers distributed geographically to the identified pre-recorded third party audio message through an active telecommunication network;
receiving the pre-recorded third party audio message from third party telecommunication device by the one point of presence server; and
associating the pre-recorded third party audio message with a pre-determined file for the identified pre-recorded third party audio message to identify a quality level associated with the pre-recorded third party audio message as the pre-recorded third party audio message was received by the point of presence server in the geographic location.

26. The method of claim 25 wherein one or more of the third party audio messages is a voice recording.

27. The method of claim 26 wherein one or more of the third party audio messages is a uniquely identifiable audio message other than voice.

28. The method of claim 26 wherein a representation of each third party audio message prior to transfer through an active telecommunication network is stored in a pre-determined file.

29. The method of claim 25 wherein one of a plurality of pre-recorded third party audio messages is selected for connection.

30. The method of claim 29 wherein service access addresses and service access procedures are stored in memory.

31. The method of claim 29 wherein one of a plurality of point of presence servers connects to a selected pre-recorded third party audio message by correctly completing service access procedures.

32. The method of claim 25 wherein the pre-determined file that is a representation of the pre-recorded audio message prior to transfer through an active telecommunication network is used to determine one of a plurality of quality levels.

33. The method of claim 32 wherein the pre-determined file is a representation of the pre-recorded audio message at a first quality prior to transfer through the active telecommunication network and the pre-recorded audio message as received by the point of presence server is at a second quality level, the first quality level being of the same quality level as the first quality level based upon a portion of the active telecommunication network between the telecommunication answering device and the point of presence server.

34. The method of claim 32 wherein the pre-determined file is a representation of the pre-recorded audio message at a first quality prior to transfer through the active telecommunication network and the pre-recorded audio message as received by the point of presence server is at a second quality level, the second quality level being of a lower quality level than the first quality level based upon a portion of the active telecommunication network between the telecommunication answering device and the point of presence server.

35. The method of claim 32 wherein the pre-determined file is a representation of the pre-recorded audio message at a first quality prior to transfer through the active telecommunication network and the pre-recorded message as received by the point of presence server is at a third quality level, the third quality level being of a lower quality level than the first quality level based upon a portion of the active telecommunication network between the telecommunication answering device and the point of presence server.

36. A method for monitoring telecommunication services end-to-end through a distributed network, the method comprising:
selecting one or more test patterns from a plurality of test patterns using a master controller coupled to a telecommunication network, each of the test patterns corresponding to at least a service;
transferring the, selected test pattern from a first point of presence server to a second point of presence server through the telecommunication network, the first and the second point of presence servers being among a plurality of point of presence servers being distributed geographically and also distributed through the telecommunication network;
receiving the selected test pattern at the second point of presence server; and
associating the selected test pattern with a pre-determined file for the selected test pattern to identify a quality level associated with the selected test pattern as the selected test pattern was received by the second point of presence server.

37. The method of claim 36 wherein the master controller provides end-to-end monitoring of the selected test pattern through a portion of the telecommunication distributed network.

38. The method of claim 37 wherein the master controller provides one or more schedules for regulating a date and time, day of week set for simulations.

39. The method of claim 37 wherein the master controller commands one or more simulation activities in a plurality of point of presence servers.

40. The method of claim 37 wherein the master controller collects and stores quality data associated with the quality level.

41. The method of claim 40 wherein the master controller analyses the quality data.

42. The method of claim 37 wherein the master controller formats one or more results of analysis for display on browser clients.

43. The method of claim 37 wherein the master controller controls an interaction with a customer's browser client.

44. The method of claim 37 wherein the master controller manages operations and data communications of the IP-WAN and the plurality of point of presence servers.

45. The method of claim 37 wherein the master controller manages an inventory of simulation resources at selected or all point of presence servers.

46. The method of claim 36 wherein each of the point of presence servers enables end-to-end simulations.

47. The method of claim 46 wherein one or more of the point of presence server collects and temporarily stores quality data resulting from end-to-end simulations.

48. The method of claim 46 wherein one or more of the point of presence server communicates quality data to the master controller.

49. The method of claim 48 wherein one or more of the point of presence server communicates connection failures to the master controller.

50. The method of claim 48 wherein one or more of the point of presence server communicates one or more time intervals as recorded during service access procedures.

51. The method of claim 48 wherein one or more of the point of presence server communicates quality data resulting from the transfer of test patterns for end-to-end simulations.

52. The method of claim 46 wherein one or more of the point of presence server controls testing systems coupled to the telecommunication network.

53. The method of claim 52 wherein one or more of the point of presence server transforms simulation commands received from the master controller into a proper syntax and semantic representations that are native to the testing systems.

54. The method of claim 52 wherein one or more of the point of presence server transforms simulation quality data received from the testing systems native syntax and semantic representations into information of the master controller.

55. The method of claim 46 wherein one or more of the point of presence server controls embedded testing systems.

56. The method of claim 55 wherein one or more of the point of presence server transforms simulation commands received from the master controller into a proper syntax and semantic representations native to the embedded testing systems.

57. The method of claim 55 wherein one or more of the point of presence server transforms simulation quality data received from the embedded testing systems native syntax and semantic representations into the master controller.

58. The method of claim 46 wherein one or more of the point of presence server controls embedded voice recognition systems.

59. The method of claim 58 wherein one or more of the point of presence server transforms simulation commands received from the master controller into a proper syntax and semantic representations native to the embedded voice recognition systems.

60. The method of claim 58 wherein one or more of the point of presence server transforms simulation quality data received from the embedded voice recognition systems native syntax and semantic representations into the master controller.

61. The method of claim 46 wherein one or more of the point of presence server capabilities are encompassed in a software only probe appropriate to efficient operation in a PC based communications client.

62. The method of claim 46 wherein one or more of the point of presence server capabilities are encompassed in a software only implementation appropriate to performing all functions of a hardware based implementation.

63. The method of claim 36 wherein one or more of the point of presence servers perform end-to-end synchronization prior to each simulation involving the transfer of one or more test patterns such that delay and latency in the transfer may be accurately measured and reported.

64. The method of claim 36 wherein the master controller manages the selection of the methods of monitoring to optimize the value of the quality information analyzed for presentation to customer's browser clients.

65. The method of claim 64 wherein the master controller selects a customer from the monitoring information store.

66. The method of claim 65 wherein the master controller selects one of customer's services from the monitoring information store.

67. The method of claim 66 wherein the master controller selects service access numbers and service access methods from the monitoring information store.

68. The method of claim 66 wherein the master controller selects one of customer's distributed telecommunication networks from the monitoring information store.

69. The method of claim 68 wherein the master controller selects, from the monitoring information store, a first point of presence server and a second point of presence server.

70. The method of claim 64 wherein the master controller manages the selection of date, and time, day of week for the start of end-to-end simulations between a plurality of pairs of first point of presence servers and second point of presence servers.

71. The method of claim 70 wherein the master controller manages the selection of start date, and time, day of week for end-to-end simulations to optimize a detection of degradations and/or failures of end-to-end service quality.

72. The method of claim 70 wherein the master controller manages the selection of start date, and time, day of week for end-to-end simulations to optimize collection of quality data in random samples to support accurate inferences from the data.

73. The method of claim 36 wherein the master controller associates each of the plurality of test patterns with at least one of three categories, a first category being optimized for rapid detection of quality degradations above a pre-selected threshold value, a second category being optimized for the rapid isolation of one or more anomalies, causing detected degradations of end-to-end service, in the distributed telecommunication network, a third category being optimized for diagnosis of observed degradation for identifying.

74. The method of claim 36 wherein the master controller stores rules and uses the stored rules to manage a selection of a method of detecting degradations in end-to-end service quality, the method isolating a geographic location of a causing anomaly in the customer's distributed network, and the method of diagnosing which of the sub-components of the customer's distributed network may be causing the anomaly, or anomalies, to optimize the system's ability to present the root cause of the anomaly, or anomalies, on the customer's browser clients.

75. The method of claim 74 wherein the rules are optimized to detect degradations of end-to-end service in a distributed telecommunication network.

76. The method of claim 75 wherein the rules are optimized to detect degradations of end-to-end service in a distributed telecommunication network by comparison with industry standard quality thresholds.

77. The method of claim 75 wherein the rules are optimized to detect degradations of end-to-end service in a distributed telecommunication network by comparison with customer defined quality thresholds.

78. The method of claim 75 wherein the rules are optimized to detect degradations of end-to-end service in a distributed telecommunication network by statistical comparisons with recent quality data collected from the current customer's same service and same active network.

79. The method of claim 74 wherein the rules are optimized to use quality data collected from a plurality of point of presence servers to isolate one or more anomalies, causing the detected degradations of end-to-end service, in the distributed telecommunication network.

80. The method of claim 79 wherein the anomalies are associated with one or more geographical locations.

81. The method of claim 79 wherein the isolated anomalies are associated with one or more of a type of network element in the telecommunication network at a geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

82. The method of claim 79 wherein the isolated anomalies are associated with one or more sub-networks selected from a access signaling network, access transport network, core signaling network, core transport network, terminating signaling network, and terminating transport network.

83. The method of claim 79 wherein the isolated anomalies are associated with one or more network transport technologies selected from a group consisting of an IP network, a mobile network, a video network, a cable network, a TDM network, an analog network, ATM network, Frame Relay network, satellite network, Ethernet network, fixed wireless network, fiber networks, microwave distribution and communication networks, a plurality of variations and customizations of each network, and any combination of these and the like.

84. The method of claim 74 wherein the rules are optimized to use quality data collected from a plurality of point of presence servers transferring test patterns via connections with a plurality of services within the same active network to isolate one or more anomalies, causing the detected degradations of end-to-end service, in the distributed telecommunication network.

85. The method of claim 84 wherein the anomalies are associated with one or more geographical locations.

86. The method of claim 84 wherein the isolated anomalies are associated with one or more of a type of network element in the telecommunication network at the geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

87. The method of claim 84 wherein the isolated anomalies are associated with one or more sub-networks selected from a access signaling network, access transport network, core signaling network, core transport network, and terminating signaling network, terminating transport network.

88. The method of claim 84 wherein the isolated anomalies are associated with one or more network transport technologies selected from a group consisting of an IP network, a mobile network, a video network, a cable network, a TDM network, an analog network, ATM network, Frame Relay network, satellite network, Ethernet network, fixed wireless network, fiber networks, and microwave distribution and communication networks.

89. The method of claim 74 wherein the rules are optimized to use quality data collected from a plurality of point of presence servers to diagnose the root cause of one or more anomalies, causing the detected degradations of end-to-end service, in the distributed telecommunication network.

90. The method of claim 89 wherein the diagnosed anomalies are associated with one or more of a type of network element in the telecommunication network at the geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

91. The method of claim 89 wherein the diagnosed anomalies are associated with one or more sub-networks selected from a access signaling network, access transport network, core signaling network, core transport network, terminating signaling network, and terminating transport network.

92. The method of claim 89 wherein the isolated anomalies are associated with one or more network transport technologies selected from a group consisting of an IP network, a mobile network, a video network, a cable network, a TDM network, an analog network, ATM network, Frame Relay network, satellite network, Ethernet network, fixed wireless network, fiber networks, and microwave distribution and communication networks.

93. The method of claim 74 wherein the master controller algorithms are optimized to use quality data collected from a plurality of point of presence servers transferring test patterns via connections with a plurality of services within the same active network to diagnose the root cause of one or more anomalies, causing the detected degradations of end-to-end service, in the distributed telecommunication network.

94. The method of claim 93 wherein the diagnosed anomalies are associated with one or more of a type of network element in the telecommunication network at the geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

95. The method of claim 36 wherein the master controller associates each of the plurality of test patterns with at least one of three categories, a first category being optimized for rapid detection of quality degradations above a pre-selected threshold value, a second category being optimized for the rapid isolation of one or more anomalies, causing the detected degradations of end-to-end'service, in the distributed telecommunication network, a third category being optimized for diagnosis of observed degradation for identifying sub-categories of the distributed network associated with anomalies, causing the detected degradations of end-to-end service.

96. The method of claim 95 wherein the third category is further associated with a sub-category optimized for the diagnosis of anomalies associated with one or more of a type of network element in the telecommunication network at the geographic location, the element being selected from a fiber, a router, a server, a TDM carrier, a packet switch, a softswitch, a packet voice gateway, a matrix switch, a Service Control Point, a Signal Transfer Point, a Service Management System, a RF transmitter, a RF receiver, a Mobile switch, an application server, a signaling system, an authentication server, an authorization server, a physical interconnection such as wires, a edge packet grooming system, and a web content caching system.

97. The method of claim 95 wherein the third category is further associated with a sub-category optimized for the diagnosis of anomalies associated with one or more sub-networks selected from a access signaling network, access transport network, core signaling network, core transport network, terminating signaling network, and terminating transport network.

98. The method of claim 95 wherein the third category is further associated with a sub-category optimized for the diagnosis of anomalies associated with one or more network transport technologies selected from a group consisting of an IP network, a mobile network, a video network, a cable network, a TDM network, an analog network, ATM network, Frame Relay network, satellite network, Ethernet network, fixed wireless network, fiber networks, and microwave distribution and communication networks.
